(19) United States
(12) Patent Application Publication
(10) Pub. No.: US 2026/0010135 A1
(43) Pub. Date: Jan. 8, 2026

(54) ENHANCED EVENT-BASED CONTROL IN PROCESS CONTROL SYSTEMS

(71) Applicant: FISHER-ROSEMOUNT SYSTEMS, INC., Round Rock, TX (US)

(72) Inventors: Mark J. Nixon, Thorndale, TX (US); Shu Xu, Austin, TX (US); Anthony Amaro, JR., Cedar Park, TX (US)

(21) Appl. No.: 18/764,697

(22) Filed: Jul. 5, 2024

(51) Int. Cl. G05B 19/042

(52) U.S. Cl. CPC G05B 19/042; G05B 2219/25413

(57) ABSTRACT

Methods, systems, and devices for event-based control in a process plant include storing in a field device a default update period for a process variable, a deadband for the process variable, and a setpoint tolerance for the process variable. The method also includes receiving, from a controller implementing a control strategy or from a second field device that receives the setpoint from the controller, a setpoint corresponding to the process variable. The method includes periodically determining a current value of the process variable, and transmitting to the controller the value of the process variable if any one of the following conditions is met: an amount of time elapsed since a most recent transmitted value was transmitted exceeds the default update period value; a difference between the current value and a most recent value exceeds the deadband value; a difference between the current value and the setpoint exceeds the setpoint tolerance.

### FIELD OF THE DISCLOSURE

The present disclosure generally relates to event-based control in process control environments and, in particular, to systems and methods for improving energy efficiency, communication efficiency, and process fidelity in process control systems using enhanced event-based control.

### BACKGROUND

Distributed control systems (DCS) are used in a variety of process industries including chemical, petrochemical, refining, pharmaceutical, food and beverage, power, cement, water and wastewater, oil and gas, pulp and paper, and steel, and are used to control batch, fed-batch, and continuous processes operating at a single site or at remote locations. Process plants typically include one or more process controllers communicatively coupled to one or more field devices via analog, digital or combined analog/digital buses, or via a wireless communication link or network. Collectively, the various devices perform monitoring, control, and data collection functions to control the process, safety shutdown systems, fire and gas detection systems, machine health monitoring systems, maintenance systems, decision support, and other systems.

The field devices, which may be, for example, valves, valve positioners, switches and transmitters (e.g., temperature, pressure, level and flow rate sensors), are located within the process environment and generally perform physical or process control functions such as opening or closing valves, measuring process parameters, etc. to control one or more process executing within the process plant or system. Smart field devices, such as the field devices conforming to the well-known Fieldbus protocol may also perform control calculations, alarming functions, and other control functions commonly implemented within the controller. The process controllers, which are also typically located within the plant environment, receive signals indicative of process measurements made by the field devices and/or other information pertaining to the field devices and execute a controller application that runs, for example, different control modules which make process control decisions, generate control signals based on the received information and coordinate with the control modules or blocks being performed in the field devices, such as HART®, WirelessHART®, and FOUNDATION® Fieldbus field devices. The control modules in the controller send the control signals over the communication lines or links to the field devices to thereby control the operation of at least a portion of the process plant or system.

Information from the field devices and the controller is usually made available over a data highway to one or more other hardware devices, such as operator workstations, personal computers or computing devices, data historians, report generators, centralized databases, or other centralized administrative computing devices that are typically placed in control rooms or other locations away from the harsher plant environment. Each of these hardware devices typically is centralized across the process plant or across a portion of the process plant. These hardware devices run applications that may, for example, enable an operator to perform functions with respect to controlling a process and/or operating the process plant, such as changing settings of the process control routine, modifying the operation of the control modules within the controllers or the field devices, viewing the current state of the process, viewing alarms generated by field devices and controllers, simulating the operation of the process for the purpose of training personnel or testing the process control software, keeping and updating a configuration database, etc. The data highway utilized by the hardware devices, controllers and field devices may include a wired communication path, a wireless communication path, or a combination of wired and wireless communication paths.

As an example, the DeltaV™ control system, sold by Emerson Process Management, includes multiple applications stored within and executed by different devices located at diverse places within a process plant. A configuration application, which resides in one or more workstations or computing devices, enables users to create or change process control modules and download these process control modules via a data highway to dedicated distributed controllers. Typically, these control modules are made up of communicatively interconnected function blocks, which are objects in an object-oriented programming protocol that perform functions within the control scheme based on inputs thereto and that provide outputs to other function blocks within the control scheme. The configuration application may also allow a configuration engineer to create or change operator interfaces which are used by a viewing application to display data to an operator and to enable the operator to change settings, such as setpoints, within the process control routines. Each dedicated controller and, in some cases, one or more field devices, stores and executes a respective controller application that runs the control modules assigned and downloaded thereto to implement actual process control functionality. The viewing applications, which may be executed on one or more operator workstations (or on one or more remote computing devices in communicative connection with the operator workstations and the data highway), receive data from the controller application via the data highway and display this data to process control system designers, operators, or users using the user interfaces, and may provide any of a number of different views, such as an operator's view, an engineer's view, a technician's view, etc. A data historian application is typically stored in and executed by a data historian device that collects and stores some or all of the data provided across the data highway while a configuration database application may run in a still further computer attached to the data highway to store the current process control routine configuration and data associated therewith. Alternatively, the configuration database may be located in the same workstation as the configuration application.

In many distributed process control systems, each field device in the process plant is assigned a unique device tag. The unique device tag provides an easy way to reference the corresponding field device. Device tags may be used during the configuration of the process control system to specify the source or destination, respectively, of an input or output to a function block in a control module. Each signal type has associated with it a particular format or set of information, and the device tag for a particular device may have associated with it a specific signal type such that when the device tag is associated with an input or output of a function block, the function block knows the format and information associated with the signal. In cases in which a field device has multiple signals associated with it (e.g., a valve may measure and transmit both pressure and temperature), device signal tags may be associated with each signal of the field device.

In “smart” field devices, one or more processors disposed in the field device may execute locally (i.e., within the field device) one or more function blocks that, in turn, may provide data to the controllers (or to other smart field devices). In so doing, the smart field devices may decrease control messaging over shared communication resources and/or may decrease the processor loading on one or more centralized process controllers by performing some control functionality locally instead of on the process controller.

With an increasing number of smart field devices being deployed, a digital communication network of limited bandwidth faces rising communication load between controllers, sensors, and actuators. The problem is exacerbated in environments in which the digital communication network is wireless, at least because first, wireless communication networks typically have more limited bandwidth and, second, because many of the wireless devices deployed in wireless communication networks are powered by batteries. As a result, traditional sampled-data control with fixed sampling periods will drain the batteries fast and significantly increase the maintenance costs of the process plant.

It is possible, in such systems, to mitigate the congestion of the communication network and improve the battery-life of the devices therein, by increasing the sampling and reporting periods such that the field devices wake up, take measurements, and transmit those measurements at longer intervals. However, doing so results in lower process fidelity, as will be described herein.

Additionally, even where plant control architecture is configured to be event-based, i.e., with sensors providing measurements, controllers computing actions, and actuators implementing control all event-triggered, it is likely that those devices are not collocated. Not until synchronization steps are executed should they be able to communicate information between the devices. Without the controllers conducting timely computation based on real-time information provided by the sensors and sending the action signals to actuators in an immediate manner, it is unlikely that an effective and efficient reference tracking and disturbance rejection will be obtained.

In some instances, for example, where a transmitter transmits only when a change in the process variable value exceeds the deadband or after a preset default sending period, the process variable may not be changing much, but may not be near the setpoint. In other instances, a controller may send a new setpoint to an actuator, but may determine that nothing is happening in response to the changed setpoint because the process variable value does not exceed the deadband for some period. This may cause the controller to ramp up the control signal. However, when the deadband is finally exceeded, the controller will then see an artificially large slope and ramp down the control signal. This type of cycling may be disadvantageous to the process, the process equipment, and the process output.

### SUMMARY OF THE DISCLOSURE

The present disclosure describes a method and system for event-based control in a process plant. The method includes storing in a first field device a default update period value for a process variable in the process plant, storing in the first field device a deadband value for the process variable, and storing in the first field device a setpoint tolerance value for the process variable. The method also includes receiving a setpoint value corresponding to the process variable, the setpoint received from a process controller implementing a control strategy in the process plant or from a second field device that receives the setpoint from the process controller. Further still, the method includes periodically determining a current measured value of the process variable, and transmitting to the process controller the current measured value of the process variable if any one of the following conditions is met: (1) an amount of time elapsed since a most recent transmitted value was transmitted exceeds the default update period value; (2) a difference between the current measured value of the process variable and a most recent measured value of the process variable exceeds the deadband value; (3) a difference between the current measured value of the process variable and the setpoint value exceeds the setpoint tolerance value.

A process control field device includes a sensor, coupled to a process in an industrial process plant, configured to obtain a measurement of a process variable of the process plant. The field device also includes a transmitter, communicatively coupled to a process controller implementing a control strategy in the process plant, the transmitter configured to transmit to the process controller the measurement of the process variable, and a memory device storing (i) a deadband value for the process variable, (ii) a setpoint tolerance value for the process variable, and (iii) a default update period value for the process variable. Further, the field device includes an input, communicatively coupled to the process controller or to a second field device, the input configured to receive from the process controller or the second field device (i) a current setpoint value corresponding to the measured process variable. A computer processor is programmed to periodically determine a current measured value of the process variable, and transmit to the process controller the current measured value of the process variable if any one of the following conditions is met: (1) an amount of time elapsed since a most recent transmitted value was transmitted exceeds the default update period value; (2) a difference between the current measured value of the process variable and a most recent measured value of the process variable exceeds the deadband value; (3) a difference between the current measured value of the process variable and the setpoint value exceeds the setpoint tolerance value.

A method for event-based control in a process plant includes receiving, at a process controller implementing a control strategy in the process plant, from a first field device in the process plant measuring a process variable of the process plant, periodic measurements of the process variable, the periodic measurements occurring at a first rate. The method also includes transmitting, from the process controller to the first field device and to a second field device, a setpoint value corresponding to the process variable measured by first the field device, the setpoint value selected to cause a control action in the second field device, and receiving, from the field device, in response to the setpoint value transmitted to the field device, periodic measurements of the process variable, the periodic measurements occurring at a second rate more frequent than the first rate. The method further includes determining, from the received periodic measurements occurring at the second rate, that the second field device received the setpoint value.

A method for event-based control in a process plant, includes configuring, in a first field device in the process plant, a default update period value for a process variable, configuring, in the first field device, a deadband value for the process variable, and configuring, in the first field device, a setpoint tolerance value for the process variable. The method also includes transmitting, from a process controller implementing a control strategy in the process plant, to each of a first field device in the process plant and a second field device in the process plant, a setpoint value corresponding to the process variable, the setpoint value configured to cause the second field device to perform a physical action in the process plant in response to receiving the setpoint value, and the first field device configured to measure the process variable. Further, the method includes receiving, from the field device, a current measured value of the process variable if any one of the following conditions is met: (1) an amount of time elapsed since a most recent transmitted value was transmitted exceeds the default update period value; (2) a difference between the current measured value of the process variable and a most recent measured value of the process variable exceeds the deadband value; (3) a difference between the current measured value of the process variable and the setpoint value exceeds the setpoint tolerance value.

A distributed process control system includes a process controller implementing a control strategy in a process plant. The system also includes a plurality of process control field devices communicatively coupled to the process controller, each of the process control field devices receiving setpoint information from the process controller, transmitting process variable information to the process controller, or both. A plurality of transmitters is also included, with each transmitter disposed in one of the plurality of process control field devices, receiving data from a corresponding sensor coupled to the transmitter, and transmitting the data to the process controller. The control strategy implemented by the process controller includes a plurality of control loops executing in the process controller, each of the control loops receiving data from one or more of the plurality transmitters and using the received data to generate an output sent as a setpoint to a corresponding one of the plurality of process control field devices. At least two of the plurality of control loops are configured to receive data from a one of the plurality of transmitters.

A method implemented in an industrial process control system includes storing, in a process control field device having a transmitter configured to transmit a process variable, a time constant associated with the process variable. The method also includes transmitting to a controller, from the field device, the process variable according to a reporting period and a deadband associated with the process variable, and receiving, at the field device, an updated time constant associated with the process variable. The method includes adjusting the reporting period, the deadband, or both according to the received updated time constant.

A method implemented in an industrial process control system includes storing, in a process control field device having a transmitter configured to transmit a process variable, a tuned time constant associated with the process variable, the tuned time constant based on a tuned value of an associated control loop. The method also includes periodically measuring the process variable during a period at which the process variable is at a first setpoint, and receiving from a controller a second setpoint for the process variable. Further, the method includes periodically measuring the process variable during a transition period in which the process variable is changing from the first setpoint to the second setpoint, calculating an updated time constant for the process variable, and transmitting to the controller the updated time constant.

A process control system includes a process controller implementing a control strategy in a process plant. Each of a plurality of process control field devices is configured to (i) perform physical actions in the process plant in response to commands from the process controller, (ii) measure process variables in the process plant and transmit to the process controller data of the measured process variables, or (iii) both (i) and (ii). An input/output (I/O) card communicatively coupled to the process controller is configured to (i) communicate to the process controller process variable data received from a plurality of process control field devices, and (ii) communicate to the plurality of process control field devices setpoint values. Each of a plurality of I/O modules, communicatively coupled to the I/O card, is configured to (i) receive data from a transmitter associated with a respective one of the plurality of process control field devices and transmit the received data to the I/O card, or (ii) transmit data from the process controller, received via the I/O card, to a respective one of the plurality of process control field devices. Each of the plurality of I/O modules configured to transmit data to the process controller is configured to transmit the data to the process controller at a first I/O module default reporting frequency. Each of the plurality of process control field devices configured to transmit measured process variables to the process controller is configured to transmit according to one or more first process variable default reporting frequencies. The I/O card is configured to transmit data to the process controller at a first I/O card default reporting frequency. Additionally, one or more of the first I/O module default reporting frequency, the first process variable default reporting frequencies, and/or the first I/O card default reporting frequency is adjusted in response to a process event.

### BRIEF DESCRIPTION OF THE DRAWINGS

The features and advantages of the methods, apparatus, and systems described herein will be best appreciated upon reference to the following detailed description and the accompanying drawings, in which:

FIG. 1 shows an example process plant, process control system, or process control environment including enhanced event-based control according to the present description;

FIGS. 2A and 2B are diagrams depicting prior art examples of single loop controllers, field devices, set points, and process variables;

FIG. 2C is a graph depicting the step response of a single prior art control loop;

FIG. 3 is a diagram depicting signals in an event-based process control system;

FIGS. 4A and 4B are block diagrams depicting respective embodiments of the enhanced event-based control architecture;

FIGS. 5A and 5B are diagrams of simulation setups comparing the event-based control schemes with and without set-point communication;

FIGS. 6A, 6B, and 6C are graphs depicting the outputs of the simulation setup depicted in FIG. 5A;

FIGS. 7A, 7B, and 7C are graphs depicting the outputs of the simulation setup depicted in FIG. 5B; using a first value for the SP_tol variable;

FIGS. 8A, 8B, and 8C are graphs depicting the outputs of the simulation setup depicted in FIG. 5B using a second, reduced value for the SP_tol variable;

FIG. 9 is a block diagram depicting an example system including the enhanced event-based control;

FIG. 10 is a flow chart depicting an example method or algorithm for transmitting process variable data in an enhanced event-based control system; and

FIGS. 11A and 11B are block diagrams illustrating alternative embodiments of the system implementing enhanced event-based control;

FIG. 12 is diagram depicting an embodiment of an extended DCS system that includes a variety of additional hardware and application options;

FIG. 13A is a block diagram depicting a first example arrangement of network integration within a compute fabric-based control architecture;

FIG. 13B is a block diagram depicting a second example arrangement of network integration within a compute fabric-based control architecture;

FIG. 14 depicts an example compute fabric-based control system with control and I/O networks;

FIG. 15A is a block diagram depicting a publish subscribe messaging protocol;

FIG. 15B is a block diagram depicting a request/response messaging protocol;

FIGS. 16A-16D depict various embodiments of trigger-based communication schemes;

FIG. 17 depicts the adjustment of communication rates according to different scenarios;

FIG. 18A is a diagram depicting the combination of messages for multiple parameters into a single PubSub message;

FIG. 18B is a diagram depicting the combination of multiple PubSub messages into a single PubSub message;

FIG. 19A is a block diagram depicting a method for subscribing to a parameter;

FIG. 19B is a block diagram depicting a method for publishing a parameter;

FIG. 20 depicts an embodiment for communicating I/O values between on-premises field devices and elements operating as part of a compute fabric; and

FIGS. 21A and 21B depict, respectively, a prior art proportional-integral function block and an improved proportional-integral-derivative function block updated to operate in accordance with the methods and systems described herein.

### DETAILED DESCRIPTION

As described above, known distributed process control systems suffer from over-utilized communication infrastructure (i.e., insufficient bandwidth) and/or energy inefficiency as a result of the methods used to determine when to transmit process variable data to a process controller. In non-event-based configurations, process variable data are transmitted on a periodic basis and, in order to maintain sufficient (though by no means optimal) process fidelity, the period is maintained fairly short. Even in event-based configurations-those that transmit process variable data, for example, when a process variable moves outside of a defined deadband, process fidelity may not be improved, even while the period of periodic reporting may be somewhat increased.

Implementations of the systems, devices, and methods for enhanced event-based control described herein can further fine-tune the transmission rate of process variable data to enhance energy efficiency and conserve communication bandwidth, while simultaneously improving process fidelity.

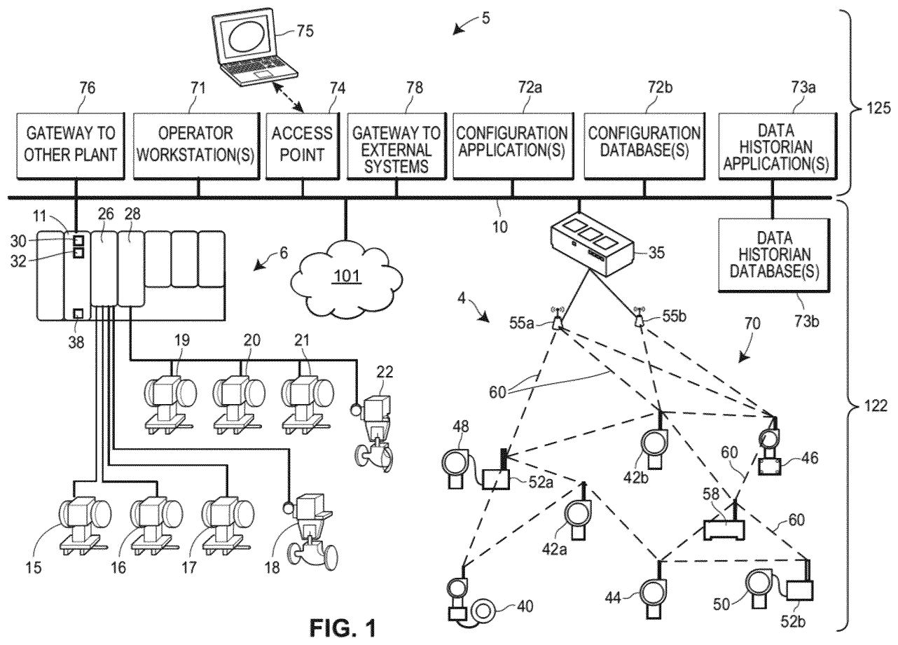

FIG. 1 shows an example process plant, process control system, or process control environment 5 including enhanced event-based control.

The process plant 5 controls a process that may be said to have one or more “process outputs” characterizing the state of the process (e.g., tank levels, flow rates, material temperatures, etc.) and one or more “process inputs” (e.g., the state of various environmental conditions and actuators, the manipulation of which may cause process outputs to change). The process plant or control system 5 of FIG. 1 includes a field environment 122 (e.g., “the process plant floor 122”) and a back-end environment 125, each of which is communicatively connected by a process control backbone or data highway 10. The backbone 10 (sometimes referred to as the “link 10” or “network 10”) may include one or more wired or wireless communication links, and may be implemented using any desired or suitable communication protocol, such as an Ethernet protocol.

At a high level (and as shown in FIG. 1), the field environment 122 includes physical components (e.g., process control devices, networks, network elements, etc.) that are disposed, installed, and interconnected to operate to control the process during run-time. For example, the field environment 122 includes an I/O network 6. By and large, the components of the I/O network 6 are located, disposed, or otherwise included in the field environment 122 of the process plant 5. Generally speaking, in the field environment 122 of the process plant 5, raw materials are received and processed using the physical components disposed therein to generate one or more products.

By contrast, the back-end environment 125 of the process plant 5 includes various components such as computing devices, operator workstations, databases or databanks, etc. that are shielded or protected from the harsh conditions and materials of the field environment 122. In some configurations, various computing devices, databases, and other components and equipment included in the back-end environment 125 of the process plant 5 may be physically located at different physical locations, some of which may be local to the process plant 5, and some of which may be remote.

### The Field Environment 122 of the Plant 5

As noted, the field environment 122 includes one or more I/O networks such as the I/O network 6, each of which includes: (i) one or more controllers, (ii) one or more field devices communicatively connected to the one or more controllers, and (iii) one or more intermediary nodes (e.g., I/O cards or modules) facilitating communication between the controllers and the field devices.

Generally, at least one field device performs a physical function (e.g., opening or closing a valve, increasing or decreasing a temperature, taking a measurement, sensing a condition, etc.) to control the operation of a process implemented in the process plant 5. The field devices may be thought of as a means to manipulate a process input (e.g., a valve position or pump status) or to measure a process output (e.g., a tank level, a flow speed, a pressure, a temperature, a temperature, etc.). Some types of field devices communicate with controllers via I/O devices (sometimes called “I/O cards”). Process controllers, field devices, and I/O cards may be configured for wired or wireless communication. Any number and combination of wired and wireless process controllers, field devices, and I/O devices may be included in the process plant environment or system 5.

For example, the field environment 122 includes the I/O network 6, which includes a process controller 11 communicatively connected, via an I/O card 26 and an I/O card 28, to a set of wired field devices 15-22. The field environment 122 also includes a wireless network 70 including a set of wireless field devices 40-46 coupled to the controller 11 (e.g., via a wireless gateway 35 and the network 10). The wireless network 70 may be a part of the I/O network 6, or may be a part of an I/O network not shown in FIG. 1 (and may include controllers or I/O cards not shown in FIG. 1).

In some configurations, the controller 11 may be communicatively connected to the wireless gateway 35 using one or more communications networks other than the backbone 10, such as by using any number of other wired or wireless communication links that support one or more communication protocols, e.g., Wi-Fi or other IEEE 802.11 compliant wireless local area network protocol, mobile communication protocol (e.g., WiMAX, LTE, or other ITU-R compatible protocol), Bluetooth®, HART®, WirelessHART®, Profibus, FOUNDATION® Fieldbus, etc.

### The Process Controller 11

The controller 11, which may be the DeltaV™ controller sold by Emerson Process Management, may operate to implement a batch process or a continuous process using at least some of the field devices 15-22 and 40-46. In addition to being communicatively connected to the process control data highway 10, the controller 11 is also communicatively connected to at least some of the field devices 15-22 and 40-46 using any desired hardware and software associated with, for example, standard 4-20 mA devices, I/O cards 26, 28, or any smart communication protocol such as the FOUNDATION® Fieldbus protocol, the HART® protocol, the WirelessHART® protocol, etc. In FIG. 1, the controller 11, the field devices 15-22 and the I/O cards 26, 28 are wired devices, and the field devices 40-46 are wireless field devices. Of course, the wired field devices 15-22 and wireless field devices 40-46 could conform to any other desired standard(s) or protocols, such as any wired or wireless protocols, including any standards or protocols developed in the future.

The process controller 11 includes a processor 30 that implements or oversees one or more process control routines 38 (e.g., that are stored in a memory 32). A “control routine” (sometimes referred to as a “control module”) is a set of instructions, executable by a processor (e.g., of the controller 11), for performing one or more operations to provide or perform on-line control of at least part of a process. Generally speaking, a control routine may be understood as software configured to implement a particular control strategy. Control routines may be saved to memory, e.g., as one or more routines, applications, software modules, or programs. Control routines may reference equipment objects to communicate with field devices corresponding to the equipment objects. A control routine may be made up of function blocks, wherein each function block is a part or a subroutine of an overall control routine. Each control routine may operate in conjunction with other control routines and function blocks to implement control routines or process control loops within the process plant. While the Fieldbus protocol and the DeltaV system protocol use control routines and function blocks designed and implemented in an object oriented programming protocol, control modules could be designed using any desired control programming scheme including, for example, sequential function block, ladder logic, etc., and are not limited to being designed and implemented using the function block or any other particular programming technique (unless otherwise stated).

Returning to the controller 11, the processor 30 is configured to communicate with the field devices 15-22 and 40-46 and with other nodes communicatively connected to the controller 11. Any control routines or modules described herein may have parts thereof implemented or executed by different controllers or other devices if so desired. Likewise, the control routines or modules 38 described herein which are to be implemented within the process control system 5 may take any form, including software, firmware, hardware, etc. Control routines may be implemented in any desired software format, such as using object-oriented programming, ladder logic, sequential function charts, function block diagrams, or using any other software programming language or design paradigm. The control routines 38 may be stored in any desired type of memory 32, such as random-access memory (RAM), or read only memory (ROM). Likewise, the control routines 38 may be hard-coded into, for example, one or more EPROMs, EEPROMs, application specific integrated circuits (ASICs), or any other hardware or firmware elements. Put simply, the controller 11 may be configured to implement a control strategy or control routine in any desired manner.

Additionally, the process controlled by the controller 11 (and any other controllers) may be characterized by “process variables.” Process inputs, process outputs, controlled variables, manipulated variables, disturbance variables, and setpoints are all example process variables. The “process outputs” may be thought of as process variables representing the existing state of the process, and the “process inputs” may be thought of as process variables representing various conditions, settings, equipment, signals, and other information that may impact execution of the process. The controller 11 may receive as “control inputs” measurements of one or more of the process outputs and may transmit one or more “control outputs” as control signals (which may be thought of as process inputs) configured to manipulate the state of a device to drive a process output to a desired state.

Example “process outputs” might include tank levels, flow rates, material temperatures, piping and tank pressures, the current states of various valves, pumps, and other equipment, etc. Process outputs are often measured and monitored to evaluate performance of the process and to inform how process inputs should be manipulated to manipulate the process outputs to desirable states.

Example “process inputs” might include the state of raw material being processed, environmental conditions, the state of equipment in the plant such as actuators (the manipulation of which may cause process outputs to change), the settings for the equipment (such as the operational settings of valves), etc. The state of any one or more of the process inputs might affect how the process executes. Process outputs and process inputs are not necessarily mutually exclusive. For example, a valve CV001 may have a position of 50% open, which may be understood as a current condition of the process and thus a process output. However, the valve position may affect other process outputs (such as flow rate) and may be measured (e.g., to verify that it reaches a desired position after having been commanded to move to the desired position). Thus, the valve position also may be understood as a process input.

As noted, example process variables include controlled variables, manipulated variables, disturbance variables, and setpoints. A “controlled variable” is a process variable (e.g., a tank level) that a controller or control routine is attempting to indirectly control by adjusting a “manipulated variable” (e.g., a water inlet valve for the tank). A control routine may adjust the manipulated variable to drive the controlled variable to a desired setpoint. A “setpoint” represents a desired value for a controlled variable. The setpoint may be automatically set by a controller based on a control routine, or may be manually set by an operator (by sending a command from an operator station to the controller, which, in turn, sends the setpoint to the appropriate field device).

Returning to the controller 11, when the processor 30 of the controller executes one or more of the control routines, the controller transmits to a field device a control signal (i.e., a control output) carrying a command or value generated based on: (i) one or more received control inputs (e.g., one or more received signals representing measurements of process outputs obtained by field devices), and (ii) the logic of the one or more control routines being implemented using values of the control inputs as inputs. The control routines may be defined by one or more software elements (e.g., function blocks). Specifically, the controller 11 may implement a control strategy using function blocks, where each function block is an object or other part (e.g., a subroutine) of an overall control routine. The controller 11 may operate in conjunction with function blocks implemented by other devices (e.g., other controllers or field devices) to implement process control loops within the process control system 5.

The term “control loop” generally refers to a subsystem of the process control system utilized to implement control of a particular aspect of the process. A control loop includes the physical components and logical components needed to control a controlled variable (often simply referred to as a process variable or PV). For example, the physical components may include (i) a sensor for measuring the PV (e.g., included in a first field device that measures a tank level), (ii) a final control element (or FCE) that can be adjusted to manipulate the process variable (e.g., a second field device that is a valve), and (iii) a controller configured to adjust the FCE (e.g., the controller 11). The logical components may include the control routine(s) at the controller that drive a control signal to cause an actuator (e.g., a valve actuator) to adjust the FCE (e.g., a valve) based on measurements received at the controller. In the given example, the valve position may be considered the manipulated variable (MV), which may be adjusted to drive the PV to a setpoint. Control loops may be utilized in a variety of scenarios. As one example, a process control system may include a control loop for controlling a water level in a tank. A process control system may include hundreds or thousands of control loops for controlling a plethora of process variables.

Returning to the function blocks that may be implemented at the controller 11, control based function blocks typically perform one of: (i) an input function, such as that associated with a transmitter, a sensor or other process parameter measurement device (sometimes referred to as “input blocks”); (ii) a control function, such as that associated with a control routine that performs PID, fuzzy logic, etc. (sometimes referred to as “control blocks”); or (iii) an output function which controls the operation of some device, such as a valve, to perform some physical function within the process control system 5 (sometimes referred to as “output blocks”). Of course, hybrid and other types of function blocks exist.

Function blocks may be stored in and executed by the controller 11, which is typically the case when these function blocks are used for, or are associated with standard 4-20 mA devices and some types of smart field devices such as HART® devices, or may be stored in and implemented by the field devices themselves, which can be the case with FOUNDATION® Fieldbus devices. One or more of the control routines 38 may implement one or more control loops which are performed by executing one or more of the function blocks.

### The Wired Field Devices 15-22 and I/O Cards 26 and 28

The wired field devices 15-22 may be any types of devices, such as sensors, valves, transmitters, positioners, etc., while the I/O cards 26 and 28 may be any types of process control I/O devices conforming to any desired communication or controller protocol. In FIG. 1, the field devices 15-18 are standard 4-20 mA devices or HART® devices that communicate over analog lines or combined analog and digital lines to the I/O card 26, while the field devices 19-22 are smart devices, such as FOUNDATION® Fieldbus field devices, that communicate over a digital bus to the I/O card 28 using a FOUNDATION® Fieldbus communications protocol. Additionally or alternatively, in some embodiments at least some of the wired field devices 15-22 or at least some of the I/O cards 26, 28 communicate with the controller 11 using the process control data highway 10 or by using other suitable control system protocols (e.g., Profibus, DeviceNet, Foundation Fieldbus, ControlNet, Modbus, HART, etc.).

### The Wireless Field Devices 40-46

In FIG. 1, the wireless field devices 40-46 communicate via a wireless process control communication network 70 using a wireless protocol, such as the WirelessHART® protocol. Such wireless field devices 40-46 may directly communicate with one or more other devices or nodes of the wireless network 70 that are also configured to communicate wirelessly (using the wireless protocol or another wireless protocol, for example). To communicate with one or more other nodes that are not configured to communicate wirelessly, the wireless field devices 40-46 may utilize a wireless gateway 35 connected to the process control data highway 10 or to another process control communications network. The wireless gateway 35 provides access to various wireless devices 40-58 of the wireless communications network 70. In particular, the wireless gateway 35 provides communicative coupling between the wireless devices 40-58, the wired devices 11-28, or other nodes or devices of the process control plant 5. For example, the wireless gateway 35 may provide communicative coupling by using the process control data highway 10 or by using one or more other communications networks of the process plant 5.

Similar to the wired field devices 15-22, the wireless field devices 40-46 of the wireless network 70 perform physical control functions within the process plant 5, e.g., opening or closing valves, or taking measurements of process parameters. The wireless field devices 40-46, however, are configured to communicate using the wireless protocol of the network 70. As such, the wireless field devices 40-46, the wireless gateway 35, and other wireless nodes 52-58 of the wireless network 70 are producers and consumers of wireless communication packets.

In some configurations of the process plant 5, the wireless network 70 includes non-wireless devices. For example, in FIG. 1, a field device 48 of FIG. 1 is a legacy 4-20 mA device and a field device 50 is a wired HART® device. To communicate within the network 70, the field devices 48 and 50 are connected to the wireless communications network 70 via a wireless adaptor 52a, 52b. The wireless adaptors 52a, 52b support a wireless protocol, such as WirelessHART, and may also support one or more other communication protocols such as Foundation® Fieldbus, PROFIBUS, DeviceNet, etc. Additionally, in some configurations, the wireless network 70 includes one or more network access points 55a, 55b, which may be separate physical devices in wired communication with the wireless gateway 35 or may be provided with the wireless gateway 35 as an integral device. The wireless network 70 may also include one or more routers 58 to forward packets from one wireless device to another wireless device within the wireless communications network 70. In FIG. 1, the wireless devices 40-46 and 52-58 communicate with each other and with the wireless gateway 35 over wireless links 60 of the wireless communications network 70, or via the process control data highway 10.

### The Back-End Environment 125 of the Plant 5

The back-end environment 125 includes various components such as computing devices, operator workstations, databases or databanks, etc. that are typically shielded or protected from the harsh conditions and materials of the field environment 122. The back-end environment 125 may include any one or more of the following, each of which may be communicatively connected to the data highway 10: (i) one or more operator workstation(s) 71; (ii) a configuration application 72a and a configuration database 72b; (iii) a data historian application 73a and a data historian database 73b; (iv) one or more other wireless access points 74 that communicate with other devices using other wireless protocols; and (v) one or more gateways 76, 78 to systems external to the immediate process control system 5.

### The Operator Workstation 71

Users (e.g., operators) may utilize the operator workstation 71 to view and monitor, via graphical user interfaces (GUIs), run-time operations of the process plant 5, as well as take any diagnostic, corrective, maintenance, or other actions that may be required.

At least some of the operator workstations 71 may be located at various, protected areas in or near the plant 5, and in some situations, at least some of the operator workstations 71 may be remotely located, but nonetheless in communicative connection with the plant 5.

Operator workstations 71 may be wired or wireless computing devices, and may be dedicated or multi-purpose devices. For example, in some embodiments, a set of applications, routines, or specially configured circuits (e.g., ASICs) that enable the functionality provided by the workstations 71 may be implemented by any suitably configured computing device or set of computing devices capable of accessing the network 10 (e.g., a desktop computer, a laptop, a mobile device such as a phone or tablet, a client/server(s) system, etc.), and may include a user interface with input components (e.g., a mouse, keyboard, touch sensors, hardware buttons, audio sensors for voice input, cameras or motion sensors for gesture input, etc.) and output components (e.g., a display, speakers, etc.) enabling the user of the workstation 71 to monitor run-time parameters, change run-time parameters, or perform or monitor diagnostic, corrective, or maintenance operations.

### The Data Historian 73a and Database 73b

The data historian application 73a collects some or all of the data provided across the data highway 10, and historizes or stores the collected data in the historian database 73b for long term storage. The data historian application 73a and historian database 73b may be centralized and may have a unitary logical appearance to the process control system 5 (e.g., they may appear to be a single application or application suite), although multiple instances of a data historian application 73a may execute simultaneously within the process control system 5, and the data historian 73b may be implemented across multiple physical data storage devices. Each instance of the data historian application 73a may be implemented on any suitable computing device or set of computing devices (e.g., a desktop computer or workstation, a laptop, a mobile device such as a phone or tablet, a client/server(s) system, etc.), which may include a user interface with input components (e.g., a mouse, keyboard, touch sensors, hardware buttons, audio sensors for voice input, cameras or motion sensors for gesture input, etc.) and output components (e.g., a display, speakers, etc.).

### The Wireless Access Points 74

The one or more other wireless access points 74 enable devices in the back-end environment 125 (and sometimes in the field environment 122) to communicate with other devices using wireless protocols, such as Wi-Fi or other IEEE 802.11 compliant wireless local area network protocols, mobile communication protocols such as WiMAX (Worldwide Interoperability for Microwave Access), LTE (Long Term Evolution) or other ITU-R (International Telecommunication Union Radio communication Sector) compatible protocols, short-wavelength radio communications such as near field communications (NFC) and Bluetooth, or other wireless communication protocols.

Typically, such wireless access points 74 allow handheld or other portable computing devices (e.g., user interface devices 75) to communicate over a respective wireless process control communication network that is different from the wireless network 70 and that supports a different wireless protocol than the wireless network 70. For example, a wireless or portable user interface device 75 may be a mobile workstation or diagnostic test equipment that is utilized by an operator within the process plant 5 (e.g., an instance of one of the operator workstations 71). In some scenarios, in addition to portable computing devices, one or more process control devices (e.g., controller 11, field devices 15-22, or wireless devices 35, 40-58) also communicate using the wireless protocol supported by the access points 74.

### The Gateways 76 and 78

The gateways 76 and 78 may interface with systems external to the immediate process control system 5. Typically, such systems are customers or suppliers of information generated or operated on by the process control system 5. For example, the process control plant 5 may include a gateway node 76 to communicatively connect the immediate process plant 5 with another process plant. Additionally or alternatively, the process control plant 5 may include a gateway node 78 to communicatively connect the immediate process plant 5 with an external public or private system, such as a laboratory system (e.g., Laboratory Information Management System or LIMS), an operator rounds database, a materials handling system, a maintenance management system, a product inventory control system, a production scheduling system, a weather data system, a shipping and handling system, a packaging system, the Internet, another provider's process control system, or other external systems.

### The Configuration Applications 72a and Database 72b

Referring still to FIG. 1, the configuration application 72a and the configuration database 72b (collectively the “configuration system 72”) may be utilized to configure certain aspects of the plant 5. Various instances of the configuration application 72a may execute on one or more computing devices (not shown) to enable users to create or change process control modules and download these modules via the data highway 10 to the controllers 11, as well as to enable users to create or change operator interfaces via which an operator is able to view data and change data settings within process control routines (e.g., the interfaces provided by the workstation(s) 71).

Typically, but not necessarily, the user interfaces for the configuration system 72 are different than the operator workstations 71, as the user interfaces for the configuration system 72 are utilized by configuration and development engineers irrespective of whether or not the plant 5 is operating in real-time, whereas the operator workstations 71 are utilized by operators during real-time operations of the process plant 5 (also referred to interchangeably here as “run-time” operations of the process plant 5).

Each instance of the configuration application 72a may be implemented on any suitable computing device or set of computing devices (e.g., a desktop computer or workstation, a laptop, a mobile device such as a phone or tablet, a client/server(s) system, etc.), which may include a user interface with input components (e.g., a mouse, keyboard, touch sensors, hardware buttons, audio sensors for voice input, cameras or motion sensors for gesture input, etc.) and output components (e.g., a display, speakers, etc.).

In operation, the configuration database 72b stores the controller configurations utilized by controllers in the plant 5, process modules representing various areas or units of the plant 5, or user interfaces created (e.g., configured) by the users.

Generally speaking, the phrase “process module” refers to a set of data, instructions, or some combination thereof representing a set of process control elements or components (e.g., equipment such as field devices, tanks, pipes, etc.) included in a particular area or unit of the plant. For example, a plant may include a “City Water” unit that takes in municipal water, stores it in a tank, and disperses it to other areas of the plant as need while maintaining a desirable tank level. The process module for the “City Water” unit may include data identifying equipment in the unit (e.g., a tank, intake and outtake pumps and valves, a level indicator for the tank, etc.); data indicating how each of the components is connected (e.g., indicating that a valve “CV013” is an intake valve upstream from the tank between the tank and water supply, indicating that it can be opened or closed to manipulate the flow of water into the tank); control routines for controlling various aspects of the unit (e.g., for opening the water supply to fill the tank when the level reaches a particular minimum level); etc. In some instances, the process module includes or references equipment objects, wherein each equipment object represents an actual equipment component in the plant. Some may find it helpful to think of a process module as a blueprint for a unit of the plant. The described systems may include a process module GUI that facilitates designing these blueprints (i.e., the process modules) and the configuration of the corresponding physical equipment in the unit represented by the blueprints (i.e., process modules).

Returning to the configuration system 72, like the data historian application(s) 73a and database(s) 73b, the configuration application 72a and configuration database 72b may be centralized and may have a unitary logical appearance to the process control system 5, although multiple instances of the configuration application 72a may execute simultaneously within the process control system 5. Further, the configuration database 72b may be implemented across multiple physical data storage devices. Accordingly, the configuration application 72a, the configuration database 72b, and the user interfaces thereto (not shown) comprise a configuration or development system 72 for control or display modules.

In further operation, the configuration system 72 enables the creation, assignment, and storage of logical identifiers of components in the field environment 122. The logical identifiers may be referenced by the control modules and devices implemented in the plant 5 to interact with the components (and associated signals) assigned to the logical identifiers.

For example, one or more devices in the plant may each have an assigned “device tag” or “DT.” A device tag (sometimes called a “field device tag”) is a logical entity that identifies a particular field device. Generally speaking, device tags are used to logically associate or assign an input or output block of a control module to a particular field device. Once a device tag is associated with a particular I/O port or I/O channel, the field device becomes bound to the block. Such process control system I/O binding may occur automatically based upon the sensing of I/O or field devices. Additionally, or alternatively, such binding may occur during configuration (e.g., by a user) of the process control module.

Further, one or more signals transmitted or received by devices in the plant may each have an assigned “signal tag,” which is sometimes called a “device signal tag” or “DST.” In some instances, DSTs only need be implemented for devices that transmit or receive more than a single signal. Collectively, the DTs and DSTs may simply be referred to as “tags,” “system tags,” or “system identifiers.” In many instances, the logical identifiers have an associated value or set of values, each of which represents a particular variable value (e.g., measurement) or command. Generally speaking, the tags may be used by the process plant 5 in both the field environment 122 and in the back-end environment 125 to uniquely identify an associated device or signal. Consequently, control routines can reference the tags and associated values to implement control of the plant.

To illustrate, for a given field device, the configuration database 72b may store information mapping or binding a logical identifier or tag to a particular hardware address or I/O channel. The hardware address may identify a particular controller, a particular I/O card connected to the particular controller, or a particular address for the I/O channel connecting the particular I/O card to the field device. In some instances, this mapping or binding may be stored at the controller 11, the user interface device 75, the operator workstation 71, or any other desired device (e.g., any device needing to resolve the logical identifier). After a tag has been bound to a hardware address or I/O channel, the tag is considered “assigned.”

### Additional Examples of the Plant 5

Although FIG. 1 only illustrates a single controller 11 with a finite number of (i) field devices 15-22 and 40-46, (ii) wireless gateways 35, (iii) wireless adaptors 52, (iv) access points 55, (v) routers 58, and (vi) wireless process control communications networks 70, FIG. 1 is only an illustrative and non-limiting embodiment. Any number of controllers 11 may be included in the process control plant or system 5, and any of the controllers 11 may communicate with any number of wired or wireless devices and networks 15-22, 40-46, 35, 52, 55, 58 and 70 to control a process in the plant 5.

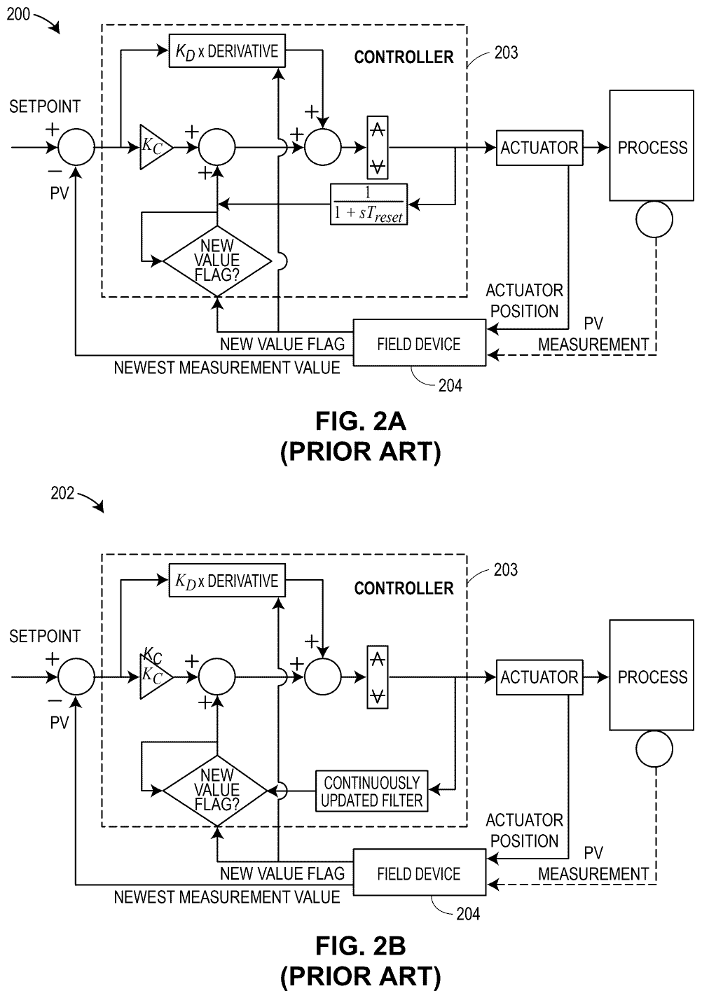

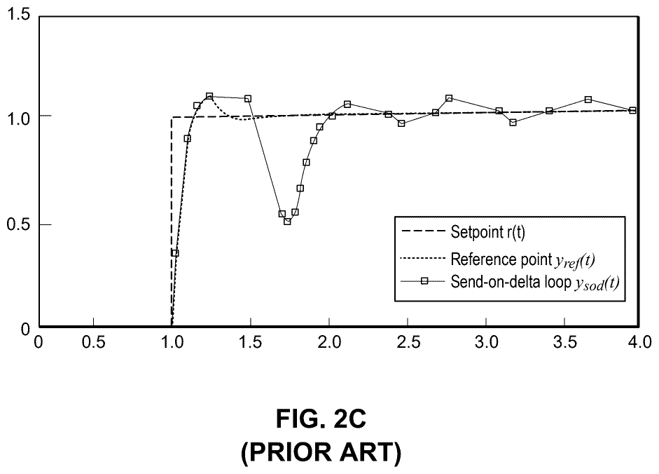

FIGS. 2A and 2B are diagrams depicting prior art examples 200, 202 of single loop PID/PIDPlus controllers 203, field devices 204, setpoints, and process variables (PVs). In the figures, dashed lines indicate event-based communication. While for PID control loops the filter output of the positive feedback network is calculated based on a constant reset value Tᵣₑₛₑₜ (usual equal to the process time constant plus the process deadtime), for PIDPlus control loops the continuously updated filter output can be calculated based on

$${F}_{N} = {F}_{N - 1} + ( {O}_{N - 1} - {F}_{N - 1} ) \times ( 1 - {e}^{\frac{- Δ T}{{T}_{reset}}} )$$

where F_{N} is the new filter output, F_{N-1} is the filter output for last execution, O_{N-1} is the controller output for the last execution, ΔT is the elapsed time since a new value was communicated, and Tᵣₑₛₑₜ is the reset time.

In addition, the derivative calculation of a PIDPlus control loop is based on the use of elapsed time:

$${O}_{D} = {K}_{P} \times {K}_{D} \times \frac{{e}_{N} - {e}_{N - 1}}{Δ T}$$

where K_{P} is the proportional gain, K_{D} is the derivative gain, e_{N} is the error for the new value communicated, e_{N-1} is the error for the last value communicated, ΔT is the elapsed time since a new value was communicated, and O_{D} is the output from derivative action.

A drawback of event-based communication protocol is that facing process variations including setpoint changes and load disturbances, this prior art event-based communication sometimes fails to generate process variable communications to the field device frequently enough that the controller can provide responsive corrections in turn. Because of the existence of deadband (i.e., a band of values for which no event will be generated), the communication of the PV is stalled if the change of PV fails to violate the deadband boundary. Such interruptions of communication might lead to underperformed control performance with issues including sticking and limit cycles.

FIG. 2C depicts the step response of a single PID control loop and send-on-delta communication (event-based control) according to the prior art. It is observed that the sticking occurs at 1.2<t<1.8 at the peak of overshoot and that limit cycles show up t≥1.8. Because the event-based controller is not invoked (“sticking”) as the signal (plant output or control error) is staying inside of the deadband of Δs, and it further leads to limit cycles due to the integral action when a new message arrives.

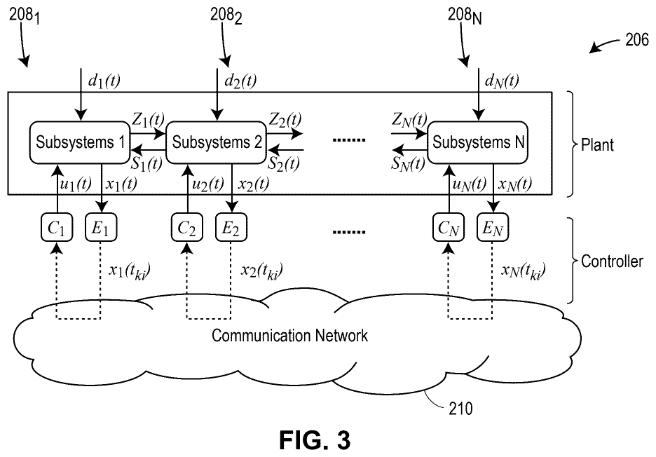

Turning to FIG. 3, a diagram 206 depicts signals in a modern plant configured with decentralized event-based control. The system is composed of numerous subsystems i=1-N communicating coupling input sᵢ and output zᵢ with one another. For each subsystem, event-based control loops 2081-208N are implemented which consist of respective event generators Eᵢ and control input generators Cᵢ. Each event generator Eᵢ takes the continuous state measurement xᵢ(t) from subsystem i, generates events at times tₖᵢ (l=1, 2, . . . , m) for the m sensor nodes, and sends them to a shared communication network 210. The connected control input generator Cᵢ responds to those discrete events by taking actions uᵢ(t) to attenuate disturbances dᵢ or track setpoint changes.

In embodiments, as contemplated herein, the decentralized event-based control architecture depicted in FIG. 3 synthesizes process simulation and control, allowing different triggering mechanisms and control algorithm designs associated with tuning rules to be tested before implementation, enhancing the overall performance in the process plant. As shown in FIG. 3, each subsystem is equipped with its own event triggering and control functionality to handle setpoint tracking and load disturbance, yet there exists information sharing among those systems.

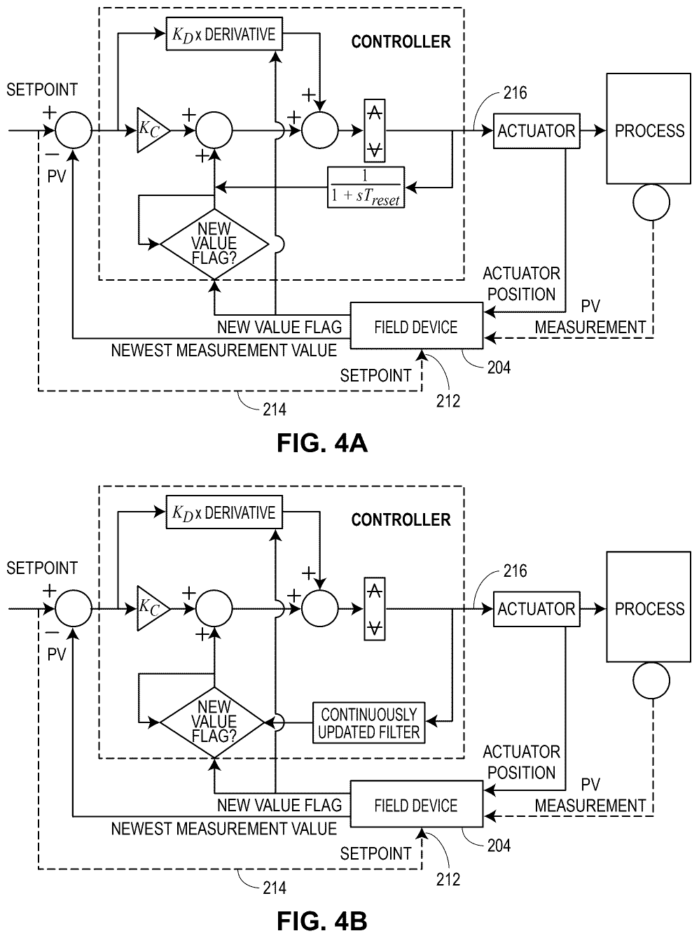

FIGS. 4A and 4B depict additional details of embodiments of the contemplated enhanced event-based control architecture. In particular, and in contrast with prior art event-based control systems, the field devices 204 include an additional input 212 that receives the setpoint 214 for the controlled variable 216. The new setpoint 214 information received by the field devices 204 may be utilized in a variety of ways as will be described herein.

### Elimination of Deadband “Sticking”

As described above, one of the problems solved by the presently described embodiments is deadband “sticking,” in which the process variable varies slowly over time in a manner that does not violate the configured deadband, which is typically centered on the process variable value. By introducing a new parameter to track the deviation of the process variable from the setpoint, communication of the new process variable value can be triggered when the process variable deviates from the setpoint by greater than a predetermined or preconfigured value. In such embodiments, the current value of the process variable will be transmitted when the time since the last transmission of the process variable has exceeded a predetermined or preconfigured value, when the process variable has changed by an amount in excess of the set deadband value, or when then the process variable has deviated from the setpoint value by more than a predetermined or preconfigured value. The following pseudocode is illustrative of this difference, with default update period being the predetermined or preconfigured value of the longest allowable time since last transmission, deadband being the deadband value, and SP_tol being the predetermined or preconfigured value over which deviation from the setpoint value will trigger a transmission:

| Prior art event-based | | Enhanced event-based | |
|---|---|---|---|
| communication protocol | | communication protocol | |
| 1: | procedure ORIGINAL | 1: | procedure ENHANCED |
| 2: | timer = timer + scan rate | 2: | timer = timer + scan rate |
| 3: | if timer ≥ default update period then | 3: | if timer ≥ default update period then |
| 4: | Transmit | 4: | Transmit |
| 5: | timer = 0 | 5: | timer = 0 |
| 6: | else | 6: | else |
| 7: | if timer = triggered update period then | 7: | if timer = triggered update period then |
| 8: | if \|PVᵢ − PVᵢ₋₁\| ≥ deadband then | 8: | if \|PVᵢ − PVᵢ₋₁\| ≥ deadband or \|PVᵢ − SPᵢ₋₁\| |
| 9: | Transmit | ≥ SP_to/ then | |
| 10: | timer = 0 | 9: | Transmit |
| | | 10: | timer = 0 |

By implementation of this additional communication of setpoint data to the field device and the associated trigger conditions, the decentralized event-based control strategy significantly enhances the systems' responsiveness to process variations while inheriting the advantages of event-based control regarding communication load relief and power minimization. Moreover, as will be appreciated in view of the remainder of the specification, the new tunable setpoint tolerance parameter offers flexible solutions to various process changes faced during the process operation, attenuating issues such as sticking and limited cycles. Advantageously, the new communication protocol is applicable to different I/O communication networks, including the HART-IP and Wireless HART networks.

In embodiments, and with reference again to FIG. 3, access to the shared communication network 210, which may be wired or wireless or a combination of wired and wireless, is reserved only to the nodes associated with events, and the number of messages are generally reduced as a result of tighter event-based messaging control. As a result, there are fewer message transmissions in the network. It follows, then, that for devices that are powered by batteries, these reductions in message transmissions will decrease energy consumption and extend battery life.

The enhanced event-based control also has benefits outside of improvements to network congestion and battery life. As described above and below, the enhanced event-based control can also decrease response time both because there is less data to process (allowing for improved responsiveness to external disturbances and setpoint changes) and because the enhanced event-based control can mitigate the sticking and limited cycles, that can affect prior art event-based control modes.

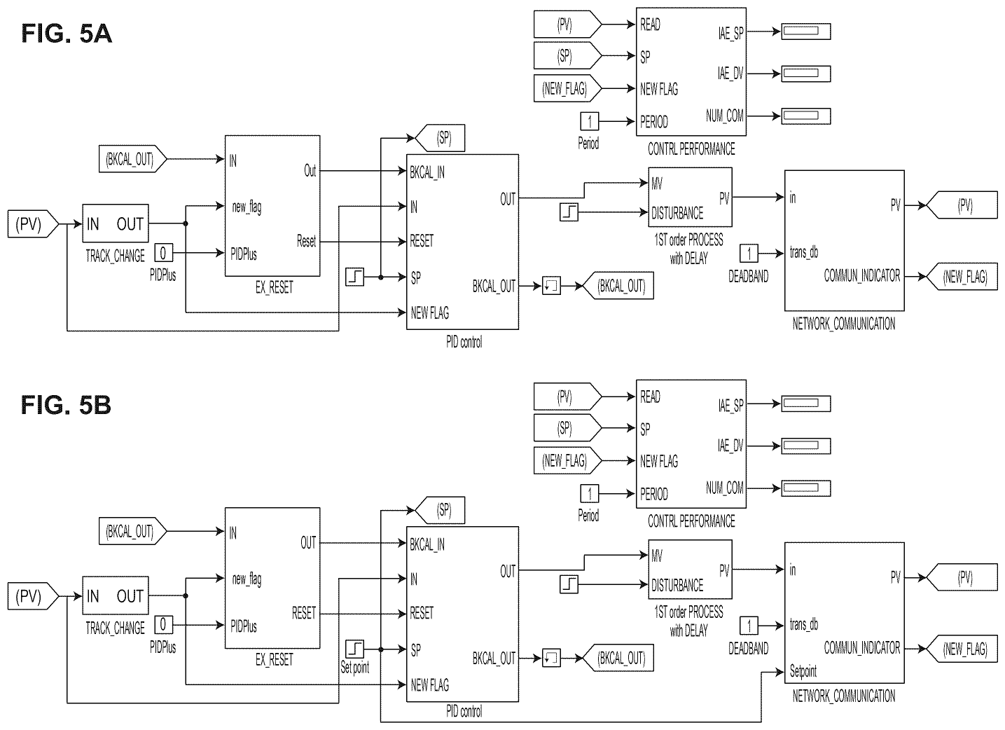

In fact, the advantages of the disclosed enhanced event-based control were validated using simulations conducted within the MATLAB® Simulink® environment. Both PID and PIDPlus controllers were considered, and two types of the I/O communication networks (HART-IP/WirelessHART) were tested. Although HART-IP is completely different from WirelessHART in the physical world, they virtually share the same event-based control simulation diagram with different timing, as depicted in FIGS. 5A and 5B. In FIGS. 5A and 5B, on top of a first order process simulation block, an event-based network communication block is created with the deadband of 1%. In addition, a block is developed to track associated measurement changes and update the control actions. Furthermore, an external reset block that is used in PIDPlus calculation is also provided. For simplicity, a parameter named “PIDPlus” is created to activate the external reset calculation and to switch between the PIDPlus and the regular PID implementations. Last, but not least, FIG. 5B differs from FIG. 5A in an extra communication of setpoint to the network communication block.

The simulations were performed under the following conditions:
First-order plus process: Gp=1/(500 s+1)
Setpoint+10% at t=10000 ms
Load disturbance: +10% at t=50000 ms; Gd=1/(500 s+1)
PID tuning: gain=1; reset=500 ms; rate=0
Trigger update period: 250 ms
Default update period: 5000 ms
Response time: 500 ms
PID execution/Sampling period: 50 ms
Deadband: 1%

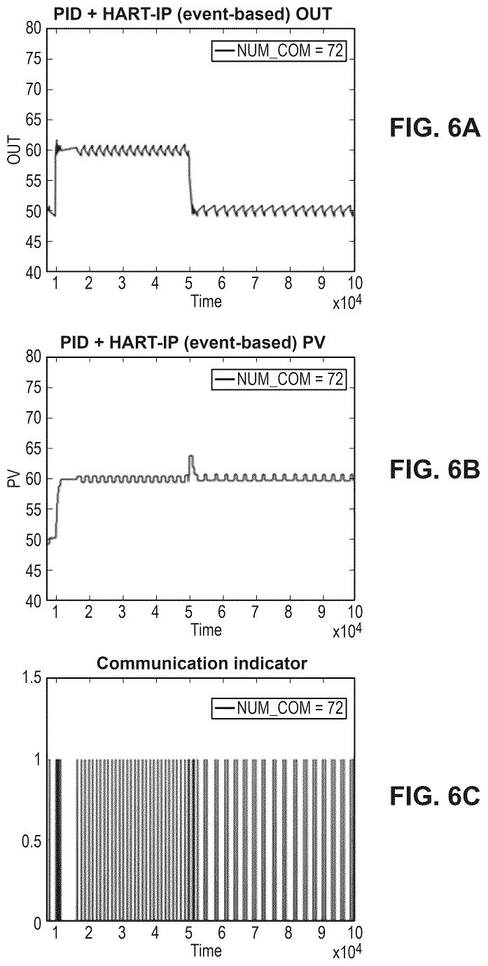

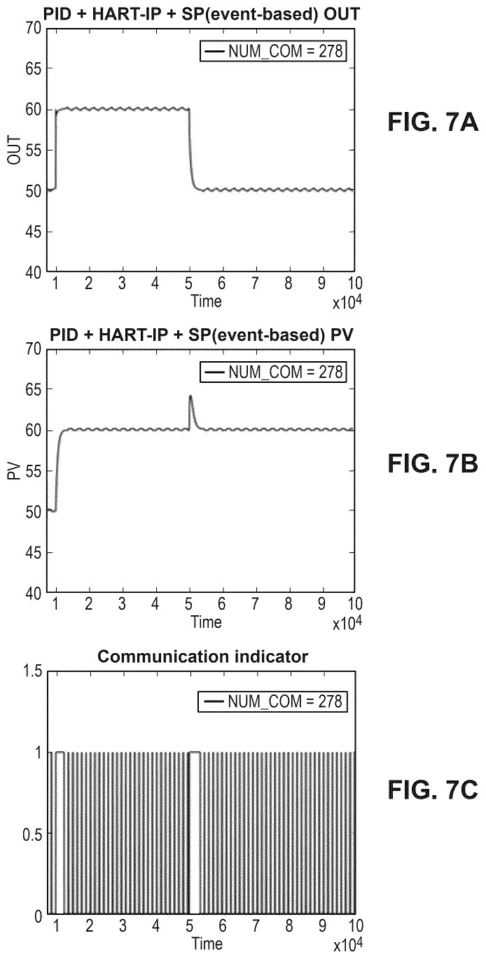

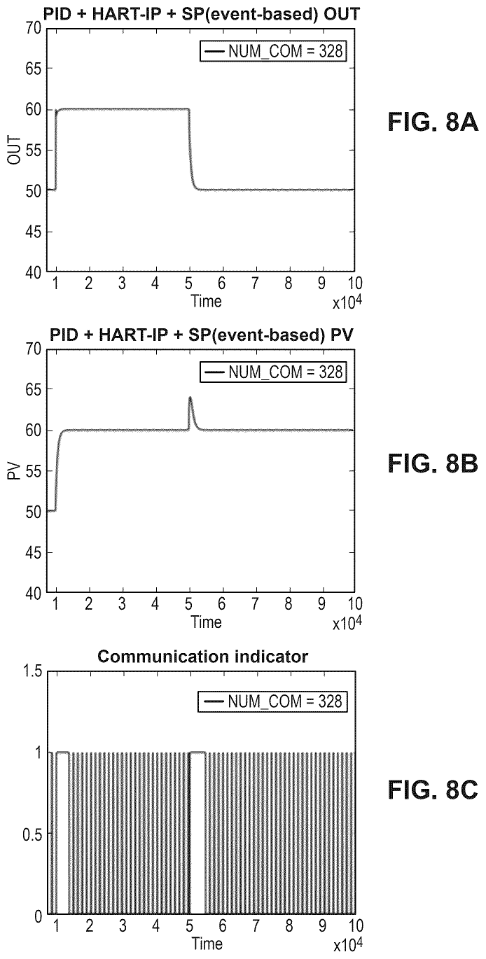

FIGS. 6A, 6B, and 6C depict, respectively, the controller output, the process variable, and the communication for the PID simulation using HART-IP, without communicating the setpoint (i.e., the prior art event-based control). Without communicating the setpoint, the application of PID is not able to deliver satisfactory results without cycling of the controller output (“OUT”) (FIG. 6A) and jumping of the process variable (“PV”) (FIG. 6B). By communicating the setpoint and introducing the SP_tol variable (set to 10% or 0.1), the cycling and jumping are significantly dampened (see, e.g., FIGS. 7A, 7B, and 7C). If the value of SP_tol is further reduced (e.g., to 1% or 0.01), a much smoother process response is observed, as in FIGS. 8A, 8B, and 8C. The simulation of PIDPlus generates similar results which lead to the same conclusions.

It is also apparent, from FIGS. 6C, 7C, and 8C, that, faced with the process variations, communicating the setpoint (as in FIGS. 7C and 8C) drastically increase the “awake” time of the field device during which the PV might be communicated as frequently as the I/O sampling rate, for example, the periods around the setpoint change and load disturbances occurring at 10000 ms and 50000 ms, respectively. Shrinking the SP_tol value from 0.1 to 0.01 further extends the awake period.

Introducing the setpoint communication to the field device significantly increases the event-based communication frequency from 72 (in FIG. 6C) to 278 and 328 (in FIGS. 7C and 8C, respectively). However, on the one hand, such a number is still very low compared with that of the regular (i.e., non-event driven) communication case where the PV is transmitted every 50 ms (1800 times in the same period); on the other hand, the majority of increased communications are distributed in the periods where process variations occurring, enhancing the responsiveness of the system.

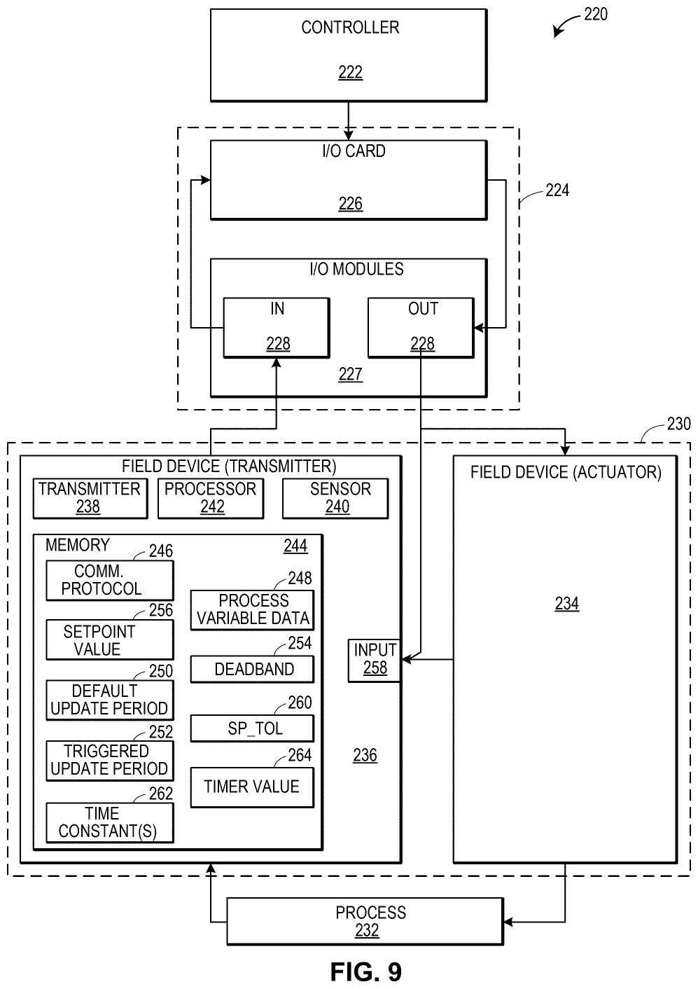

Turning now to FIG. 9, an example system 220 includes the enhanced event-based control according to described embodiments. The system 220 includes a controller 222 communicatively coupled by an I/O subsystem 224 to one or more field devices 230 controlling a process 232. The controller 222 implements a control strategy in the process plant, outputting various setpoints to field devices in response, at least in part, to process variables measured by sensors in the process plant. The control strategy is implemented within the controller as one or more control modules or control loops, as will be understood. The I/O subsystem 224 includes an I/O card 226 sending and receiving data via a bank 227 of I/O modules 228, each of which I/O modules 228 converts signals between the field devices 230 and the I/O card 226, and each of which may be, for example, a discrete input (DI) module, a discrete output (DO) module, an analog input (AI) module, an analog output (AO) module, etc. Of course, while FIG. 9 depicts only a single controller 222, a single I/O card 226, a single bank 227 of I/O modules 228, etc., it will be understood that an industrial process plant may have many controllers 222, many I/O cards 226, many banks 227 of I/O modules 228, and a multiplicity of field devices 230.

In the system 220 of FIG. 9, the field devices 230 include an actuator device 234 and a transmitter device 236. While depicted as separate entities, the actuator device 234 and the transmitter device 236 may be incorporated within the same device body, as would be readily appreciated by skilled practitioners. The transmitter device 236 includes a transmitter 238 operable to transmit process variable data (e.g., data representing values of process variables) measured by a sensor 240 and coupled to a processor 242 that is, in turn, coupled to a memory 244.

The memory 244 stores a variety of data including a communication protocol 246 executed by the processor 242 that determines when the transmitter 238 will transmit the process variables measured by the sensor 240. The communication protocol 246 uses other data stored in the memory 244, which data include process variable data 248, a default update period 250, a triggered update period 252, a deadband value 254 (expressed, typically, as a percentage or tolerance that can be compared to a last-transmitted process variable), a setpoint value 256 received at an input 258, and a setpoint tolerance value 260. In embodiments, the memory 244 may also store one or more time constants 262, which may be used by the processor 242 according to the communication protocol 246 to determine when to cause the transmitter 238 to transmit process variable data. The data in the memory 244 also includes a timer value 264. As depicted in FIG. 9, the setpoint value 256 can be received at the field device 236 from either the controller 222 implementing the control loop, from another field device (e.g., the actuator 234), or from multiple sources (e.g., to verify that the received setpoint data is correct).

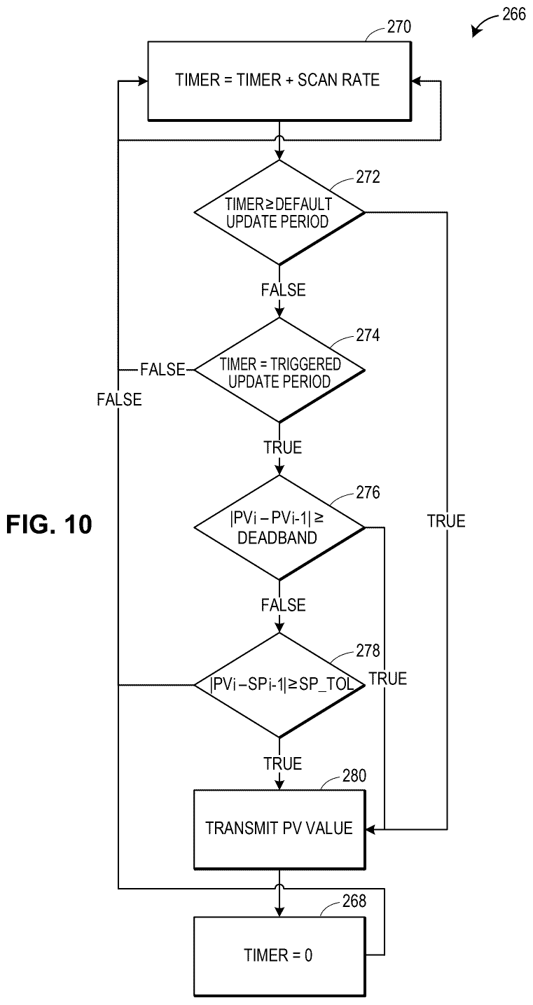

FIG. 10 depicts an example method or algorithm 266 for transmitting process variable data in an enhanced event-based control system. In the method 266, the timer value 264 is initialized to 0 after each transmission of the process variable value (block 268). Thereafter, the timer value 264 is updated according to the scan rate of the process variable and/or the execution rate of the method 266 (block 270). If the timer value is equal to or greater than the default update period 250 (block 272), then the current process variable value is transmitted to the controller 222 (block 280). If, on the other hand, the timer value is less than the default update period 250, the method 266 determines whether the timer is equal to the triggered update period (block 274) and, if so, proceeds to evaluate criteria to determine whether to transmit the current process variable value. If it is not, the method 266 updates the timer value (block 270) and continues execution.

If the timer value is equal to the triggered update period (block 274), the method 266 first includes determining whether the change in the process value between the current process variable value and the most recently transmitted process variable value is equal to or exceeds the deadband 254 (block 276). If the difference between the current process variable value and the most recently transmitted process variable value is outside of the deadband, the method 266 causes the transmitter 238 to transmit the current process variable value to the controller 222. If the difference between the current process variable value and the most recently transmitted process variable value is not outside of the deadband, the method 266 evaluates whether difference between the current process variable value and the setpoint value 256 is equal to or greater than the setpoint tolerance value 260 (block 278). If so, the method 266 causes the transmitter 238 to transmit the current process variable value to the controller 222; if not, the method 266 updates the timer value (block 270) and continues executing.

Of course, a field device may participate in more than one control loop. That is, the values of the process variable may be used by multiple control loops, operating on the same or different controllers, to control different actuators or other devices. As such, a set of data including a first default update period 250, a first triggered update period 252, a first deadband value 254, and a first setpoint tolerance value 260 may be associated with a first control loop, while a second set of data including a second default update period 250, a second triggered update period 252, a second deadband value 254, and a second setpoint tolerance value 260 may be associated with a second control loop on the same controller or a different controller. (The setpoint value 256 is specific to the controlled variable and, as a result, there can only be one setpoint value for each controlled variable.) In the event that a single field device includes multiple process variables (and therefore multiple setpoints), each setpoint/process variable pair may be associated with a respective control loop according to the embodiments described herein.

In other implementations, as should be apparent, a field device may have multiple transmitters each of which is part of a different control loop. In such implementations, a field device may receive and store multiple setpoints, with each setpoint for a respective one of the process variables associated with the multiple transmitters. As such, the field device may report values of different process variables to respective control loops according to respective setpoint values and respective setpoint tolerance values, deadbands, etc.

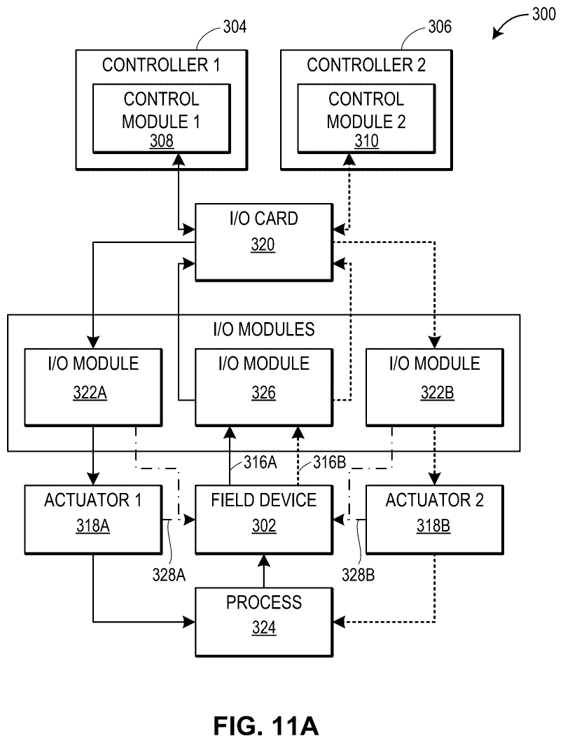

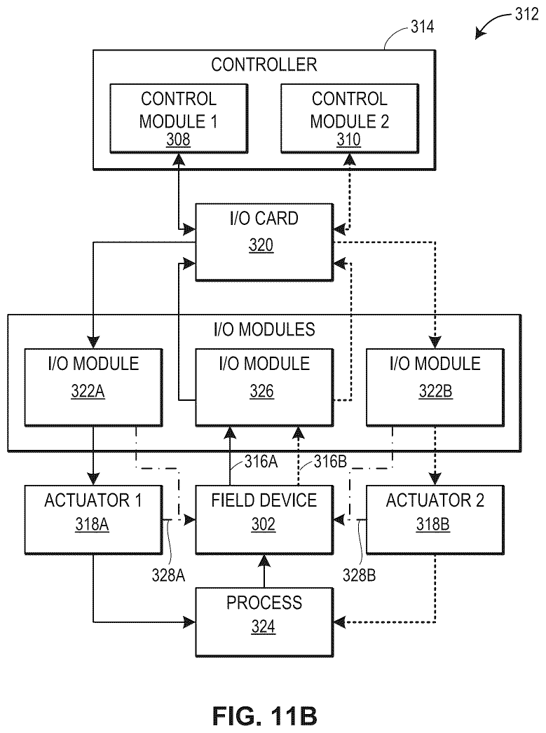

FIGS. 11A and 11B illustrate some of these embodiments. In FIG. 11A, an embodiment 300 is depicted in which a field device 302 is part of two different control modules 308 and 310, each executing on respective controllers 304 and 306. In FIG. 11B, an embodiment 312 is depicted in which the field device 302 is part of two different control modules 308 and 310 both executing on a single controller 314. In either case, as described above, the field device 302 may have one transmitter or multiple transmitters (two, in FIGS. 11A and 11B), and each transmitter may send corresponding data 316A, 316B according to the event-based control algorithms operating according to set-point data received from one or more actuators 318A, 318B. As should be understood from the FIGS. 11A and 11B, the control modules 308, 310 send set-point data to the actuators 318A, 318B via an I/O card 320 and output I/O modules 322A, 322B. The actuators interact with the process 324, and the transmitter(s) of the field device 302 send data back to the control modules 308, 310 via the input I/O module 326 and the I/O card 320 according to set-point data 328A, 328B received at the field device 302, and the event-based algorithms described herein.

Referring again to FIG. 9, in some embodiments, the field device 236 may also receive (e.g., from the controller 222) and store (e.g., in the memory 244) an indication of whether the control loop(s) of which the transmitter is a part is/are operating in automatic mode or in manual mode. In the event that one or more control loop(s) are operating in manual mode, the processor 242 may be programmed to cause the transmitter to go into sleep mode (i.e., not transmit process variable values), to transmit only according to default transmit periods, and/or could suppress the transmission of alarms.

In embodiments, the default update period 250 for the process variable—which, as should be apparent, may be different between different process variables—may be received from the controller 222 upon initialization or may be changed by the controller 222 according to various process states. Similarly, the deadband value 254 may be received from the controller 222 and, in embodiments, may be adjusted during execution of the process.

In the same manner, the setpoint tolerance value 260 may be received from the controller 222. As with the deadband value 254 and the default update period 250, the setpoint tolerance value 260 may be adjusted during execution of the process. In particular, the setpoint tolerance value 260 may be adjusted in a variety of ways to adjust reporting of process variable values according to need. As one non-limiting example, the setpoint tolerance value 260 may be “opened up” (i.e., increased) upon setting of a new setpoint value 256 to prevent excessive reporting of changing process variable values in response to a change in the setpoint value 256. The setpoint tolerance value 260 may then be “closed” (i.e., decreased) as the process variable value approaches the setpoint value 256, such that smaller deviations from the setpoint value 256 will trigger reporting once the process variable reaches or approaches the setpoint value 256. More complicated arrangements may also be programmed, in embodiments, such that the setpoint tolerance value 260 remains relatively closed (or closes further) around the process variable value upon changing of the setpoint value 256 so that the controller 222 can register that the change in setpoint value 256 was in fact received by the field device; thereafter, the setpoint tolerance value 260 may be opened up to decrease reporting as the process variable value trends toward the setpoint value 256, and may be closed again as the process variable value approaches the setpoint value 256.

In embodiments, the deadband value 254 may be programmed to change in real-time according to the difference between the setpoint value and the process variable value, such that, for example, the deadband is decreased (narrowing the deadband) as the difference between the setpoint value and the process variable decreases or such that the deadband is increased (widening the deadband) when the difference between the setpoint value and the process variable reaches (or approaches) zero. In particular embodiments, the deadband may be asymmetrical with respect to the process variable and/or with respect to the setpoint. For example, upon a change of the setpoint value 256, the deadband may be set such that its boundaries are outside of both the current process variable value and the setpoint value 256, and the deadpoint may contract (“close”) around the current process variable value and the setpoint value 256 as the current process variable value trends toward the setpoint value 256.

The controller 222 may, in turn, use changes in the transmission rate from the field device 236 as confirmation that the field device 234 received the change in the setpoint value 256, in embodiments. For example, a change in the setpoint value 256 will, in many cases, exceed the setpoint tolerance value 260. As a result, the transmitter 238 in the field device 236 will transmit the current process variable value with each triggered update period until the current process variable value is within the range set by the setpoint tolerance value 260. This increase in reporting to the controller 222 of the current process variable value, occurring contemporaneously with a command from the controller 222 to change the setpoint value 256, may serve as confirmation to the controller 222 that the command to change the setpoint value 256 was received by the field devices 230 and is being implemented, particularly in the cases where the field device 236 associated with the transmitter 238 receives the setpoint value 256 from the actuator field device 234, or where the actuator and transmitter are both part of the same field device. Moreover, the processor 242 may be configured to cause the transmitter 238 to transmit current process variable values more frequently for some predefined period of time upon receipt of a new setpoint value 256 specifically to provide feedback to the controller 222 that the command to change the setpoint value 256 was received, before adjusting the deadband value 254 or setpoint tolerance value 260 to achieve desired process variable reporting parameters (e.g., minimizing reporting during a portion of the transition period and then “closing” the deadband and/or setpoint tolerance as the current process variable value reaches the setpoint value 256) during and after the transition between a previous setpoint value 256 and a newly set setpoint value 256.

Additionally, in some embodiments a time constant 262 associated with the process variable may be received and stored at the field device (in the memory 244). The time constant may be used to adjust one or more of the deadband value 254, the default update period value 250, or both. In this manner, the reporting frequency can be adjusted according to the time constant 262, and may be updated according to the time constant 262 if the process or the tuning of the process changes.

The time constant 262 may also be calculated in real time by the controller 222 or the field device 234. In particular, because the field device 234 is aware of the set point changes (e.g., can store several in the memory 244), the field device 234 can calculate for a given control loop the actual time constant 262 in real time by recording and analyzing the changes in process variable values resulting from each change in the set point. The real-time time constant 262 may be compared to the tuned/commissioned time constant, either at the field device 234 or at the controller 222 (after being communicated from the field device 234 to the controller 222), to determine if there is tuning degradation. If calculated at the field device 234, the field device 234 may tell the controller that the control loop needs to be retuned or can indicate that the transmitter requires recalibration. In embodiments, updated time constants are calculated for each of a predetermined number of most-recent setpoint changes, and an updated time constant is transmitted to the controller when an average of the updated time constants differs from a tuned time constant by a predetermined amount.

While described throughout as relating to reporting frequency of process variables by the transmitters in field devices, the enhanced event-based control methods contemplated herein may alternatively or additionally be applied, in embodiments, to communication between the I/O card 226 and the controller 222 and/or between the I/O modules 228 and the I/O card 226. Such communication schemes can be used to limit unnecessary communications between and among the controller 222, the I/O card 226, the I/O modules 228, and the field devices 230, saving communication bandwidth and reducing power consumption in the same manner as described throughout this specification. Specifically, reporting (transmitting) frequency of each or all parameters may be decreased and/or increased according to respective relationship(s) between setpoint(s) and other data point(s) (e.g., deadband value(s), default reporting frequency(ies), setpoint tolerance value(s), process variable value(s)) related to the individual reported parameters.

Of course, when configured to report all values received from the field device(s) 230, the I/O modules 228 and/or I/O card 226 reporting frequency(ies) would mirror those generated by implementation of the setpoint-aware event-based communication scheme. However, in some instances, it may be desirable from a control standpoint to increase the reporting frequency of a first process variable in response to an event other than a change in the first process variable or its setpoint. As should by now be understood, the controller 222 may send a command to the field device 230 to decrease/increase its default reporting period (increase/decrease its default reporting frequency). However, the controller 222 may also send commands to the I/O card 226 and/or to the I/O modules 228 to increase/decrease respective default reporting frequencies for one or more process variables such that values for the one or more process variables are sent between the I/O modules 228 and the I/O card 226 more or less frequently, and/or such that values for the one or more process variables are sent between the I/O card 226 and the controller 222 more or less frequently.

In this way, reporting schemes may be implemented in which a change to a setpoint of a control variable related to a first field device results in a change in reporting frequency of a process variable related to a second field device. In some embodiments, the change may be implemented by sending commands from the controller 222 to the field devices 230 to change their default reporting period. However, in other embodiments, the field devices 230 may transmit process variable values at fixed rates, and the I/O modules 228 and/or the I/O card 226 may determine how frequently to provide the data to the controller 222 based, for example, on changes in setpoints. That is, because changes in setpoints all go through the I/O card 226 and I/O modules 228, these elements are always aware of the changes, and can adjust the frequency at which data are provided back to the controller 222 accordingly.

In still other embodiments, the I/O modules 228 and/or I/O card 226 may be programmed to adjust the reporting frequency, the deadband, and/or the setpoint tolerance associated with various ones of the process variables according to setpoint changes of one or more of the control variables.

### Cloud-Based System Applications

It should also be understood that, while described to this point as hardware components, components herein may be implemented, in embodiments, as one or more software modules instantiated in a computing cluster or compute fabric operating locally within a process plant or on a shared compute resource. The components contemplated as potentially existing partially or fully as instantiated software modules (individually or, in various combinations, as a group) include at least the controller 222, the I/O card 226, the I/O modules 228, and the elements of the transmitter 236 of the field device 230 other than the sensor 240 and the actuator 234.

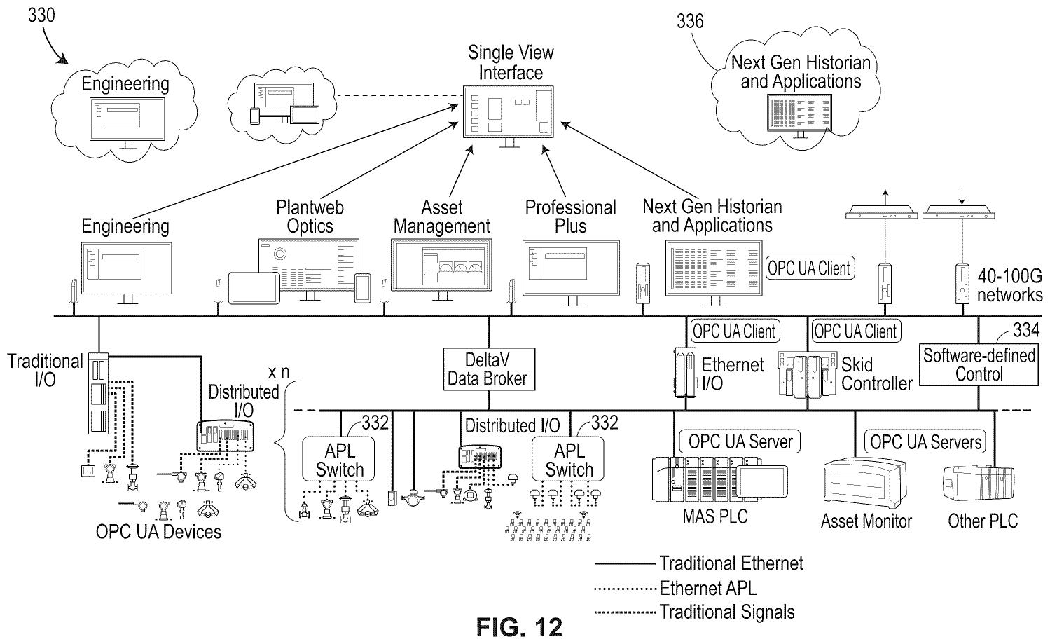

An example of these extended systems is shown in FIG. 12, which depicts an embodiment of an extended DCS system 330 that includes a variety of additional hardware and application options. The introduction of Advanced Physical Layer (APL) devices 332, edge devices, and software defined control concepts 334 combined with cloud-based applications 336, further extends the role of DCS systems and expands the variety of ways that the concepts outlined throughout this specification can be implemented. Moreover, the combination of software defined control and cloud-based applications may serve to further extend the DCS system 330 toward control systems operating on a compute fabric—integrating local and cloud-based resources, for example—in which, for example, the only devices that must be physically present in the plant are the field devices that perform physical measurement or control functions (e.g., valves, transmitters, actuators, etc.).

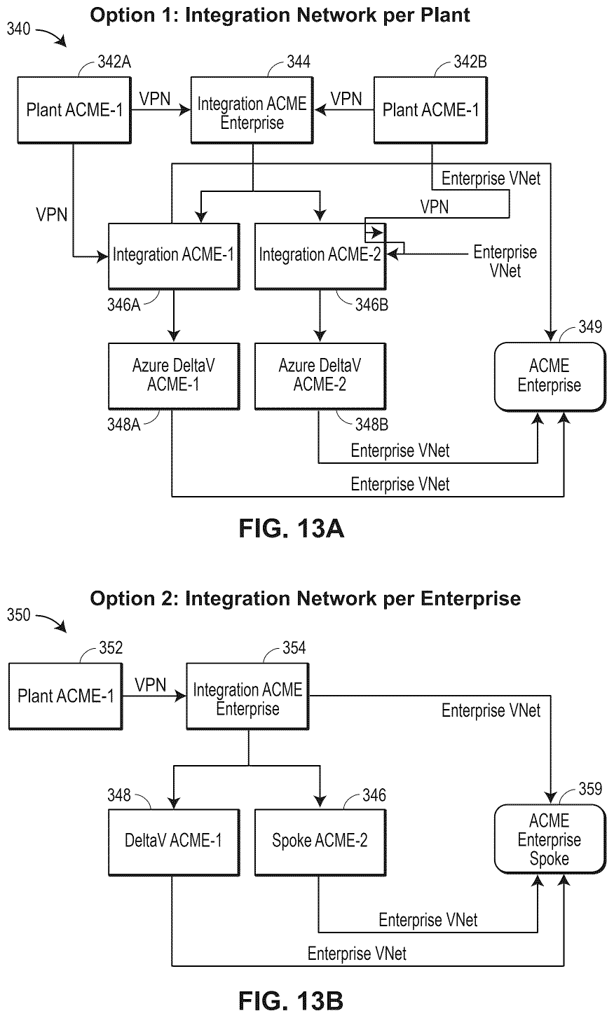

FIGS. 13A and 13B are block diagrams depicting two potential arrangements 340, 350 of network integration within a compute fabric-based control architecture. Such compute fabric-based control architectures may, for example, include network integration on a per-plant basis, as depicted in the arrangement 340 of FIG. 13A. In the arrangement 340, multiple plants 342A, 342B belonging to an enterprise are coupled via virtual private network (VPN) connections to an enterprise integration component 344 that is, in turn, coupled to plant-level integration components 346A, 346B coupled to respective cloud computing instances 348A, 348B. Each of the integration components 346A, 346B and each of the cloud computing instances 348A, 348B communicates via an enterprise-level virtual network with the enterprise 349. In contrast, in the arrangement 350, a plant 352 is coupled via a VPN connection to an enterprise integration component 354 that is coupled directly to an enterprise 359 via an enterprise-level virtual network. The integration component 354 couples to one or more compute fabric-based control interfaces 346, 348.

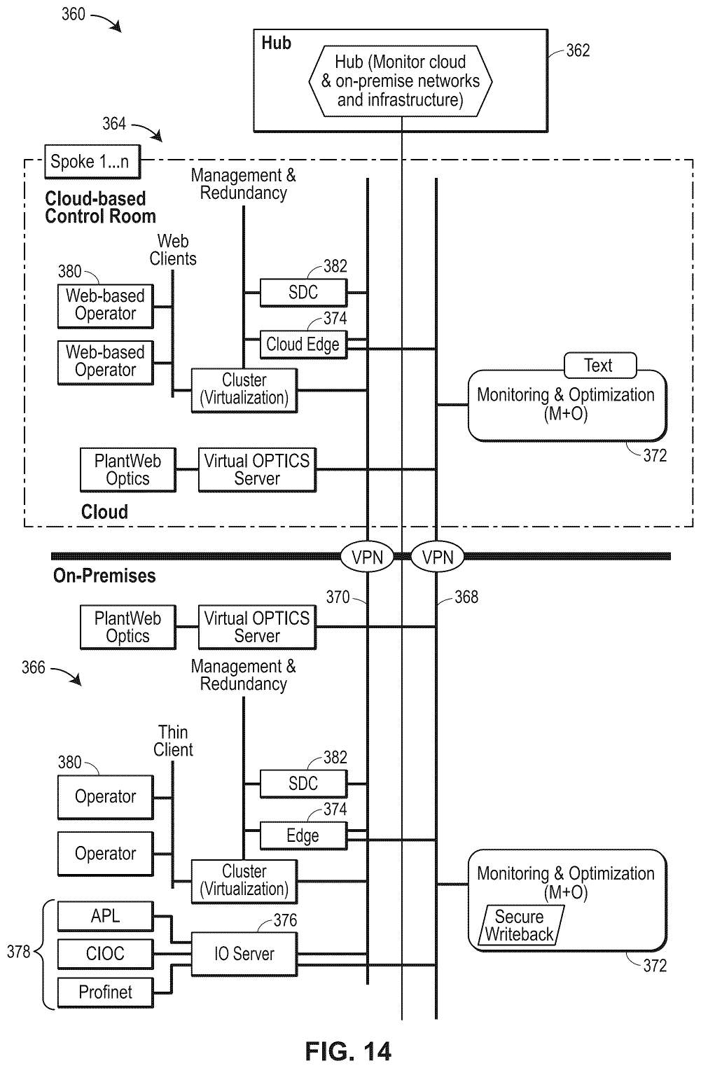

Supporting the compute fabric-based enterprise control systems requires control and I/O networks capable of traversing the one or more plants and the cloud portions of the compute fabric-based control system. FIG. 14 depicts an exemplary compute fabric-based control system 360 with control and I/O networks. The system 360 includes a management hub 362 that allows the purveyor of the architecture to monitor the cloud-based and on-premise networks and infrastructure, as well as provide information and support to the various enterprises making use of the compute fabric-based architecture. A cloud portion 364 of the system 360 may include a variety of “spokes,” each of which generally corresponds to an enterprise (or a plant, depending on the embodiment) operating on the system 360. An on-premise portion 366 of the system 360 may include portions of the system 360 that are located on the plant premises, as described below.

Two primary networks traverse the system 360. A plant IP network 368 provides IP communication between the cloud portion 364 and the on-premise portion 366 and, in particular, supports monitoring and optimization functions 372 in both portions 364, 366 of the system 360. The plant IP network 368 also couples to edge devices 374 in both portions 364, 366 of the system 360, to the I/O server 376 in the plant that, in turn, is coupled to the field devices (not shown) through various interfaces 378 (e.g., advanced physical layer, Profinet, etc.). At the same time, an area control network (ACN) 370 also couples the cloud portion 364 and the on-premise portion 366 of the system 360. The ACN 370 couples operator workstations 380 in a compute fabric-based control room including cloud-based and/or on-premise control rooms to the I/O server 376 (and, by extension, to the field devices through the interfaces 378), to software-defined control resources 382, and to the edge devices 374.

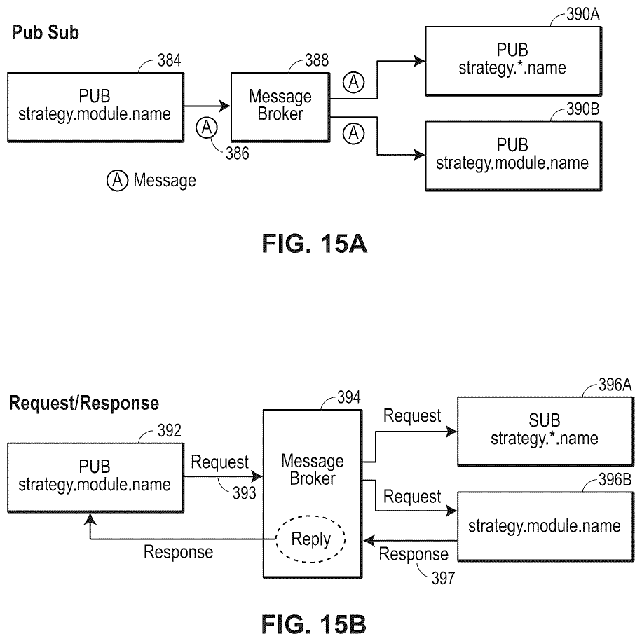

Many of the applications active within the process control system (e.g., control applications, alarming applications, and I/O applications), in the context of the compute fabric-based control system, operate as microservice-based components. The microservices can be instantiated on-premises, in the cloud environment, or distributed between the cloud and on-premises environments, and communicate between the microservices using messaging services that employ either subject-based messaging (publish-subscribe) or request-reply/response messaging. FIGS. 15A and 15B are block diagrams depicting, respectively, the publish-subscribe and request/response messaging protocols. In subject-based messaging, messages are scoped with a subject such that any interested party (e.g., service, operator, etc.) can subscribe to the messages based on the subject. In simple terms, a subject is a string (e.g., module.parameter) that forms a name that both the publisher (also referred to herein as a data consumer or a data-consuming entity) and subscriber (also referred to herein as a data generator or a data-generating entity) use to share messages. Most of the communications in a distributed control system are via publish-subscribe messaging and, in particular, most real-time values, alarms, alerts, etc. are communicated with publish-subscribe messaging. As depicted in FIG. 15A, a publisher 384 (e.g., a field device, an I/O device, an application, etc.) publishes a message 386 (e.g., a value, alarm, etc.) to a message broker service 388 that manages the various publishers and subscribers and passages published messages to subscribers 390A, 390B, etc. of the published subject matter. A subscriber may subscribe to a group of subjects (as depicted with respect to subscriber 390A) or may subscribe to a very specific subject (as depicted with respect to subscriber 390B). Every time a message is published by any publisher, the message broker ensures that the message is passed to any subscriber that has subscribed to the subject of the published message. Request/response messaging is used in distributed applications and systems to support write requests such as changing a mode, a setpoint, or a parameter. The request/response messaging protocol is also used for downloads, firmware updates, etc. In a request/response messaging protocol, a source system (a requester) sends a message to a target system (a responder) and expects a message in response. As depicted in FIG. 15A, a requester 392 sends to a message broker service 394 a request 393 associated with a specific subject. The message broker service 394 publishes the request 393 to responders 396A, 396B of the subject. Each of one or more of the responders 396A, 396B sends a response 397 back to the message broker service 394, which response(s) is/are then sent to the requester 392 as a reply. For example, if the response is from a single module, then only that module would send a response (as depicted in FIG. 15B). Of course, if the response were required from multiple modules-such as, for instance, with an alarm regeneration request-then each module would provide a response message.

In general, communications between microservices in a compute fabric-based architecture (not specifically a compute fabric-based control architecture) may send messages frequently without regard to bandwidth limitations, timing requirements, and other concerns that may be present in an industrial control architecture. Thus, in a compute fabric-based control architecture, it may be necessary to design and/or invoke mechanisms to reduce the number of messages between microservices, similar to and/or including mechanisms at least similar to those described above with respect to event-based control in more traditional process control environments. As will be described below, these mechanisms may implement combination and compression of content into fewer messages, as well as event-based enhancements facilitating consistent (or improved) control system operations while decreasing the number of messages transmitted between the microservices.

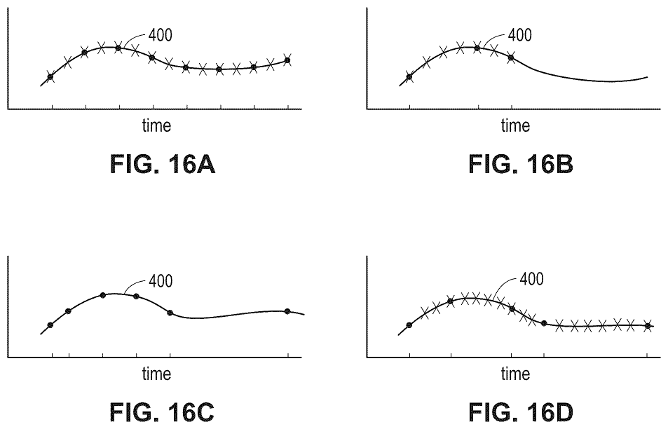

Event-based enhancements may include the utilization of triggers to indicate when values (e.g., I/O parameters, device, parameters, module parameters, alarms, alerts, etc.) should be communicated. The triggers may be similar to, or different from, those described above with respect to traditional process control systems. FIGS. 16A-16D depict various embodiments of trigger-based communications. FIG. 16A depicts a time-based or periodic trigger that causes values of a signal 400 (i.e., data) to be transmitted on a periodic basis (e.g., every second, every one minute, etc.). The period in question may be the same or different as the sampling period for the signal 400. For example, in embodiments, the signal is sampled every 100 milliseconds, but the communication is triggered every 1 second. In the periodic trigger scenario, transmission of data occurs whenever the time since the last transmission exceeds a threshold, T_{A}:

$$( {t}_{z} - {t}_{last} ) \geq {T}_{A}$$

where t_{z} is the current time, tlast is the time of the last transmission, and T_{A} is the threshold difference between t_{z} and tlast that triggers a transmission.

A threshold-based trigger in accordance with the present description is depicted in FIG. 16B. As shown in FIG. 16B, a threshold-based trigger causes the value of a signal 400 (i.e., data) to be transmitted when the value exceeds some threshold absolute or relative difference. The difference may be expressed as a difference in the value of the sampled signal 400 (e.g., the values changes by 0.5 or more):

$$\vert ( {S}_{z} - {S}_{last} ) \vert \geq Δ s$$

where S_{z} is the most recent sample value of the signal 400, Sₗₐₛₜ is the value of the signal 400 the last time the value was transmitted, and Δs is the threshold difference in the values of the signal 400, expressed in the units of the signal 400, or may be expressed as a percentage difference of the value of the sampled signal 400 (e.g., the value changes by 10% or more):

$$\frac{\vert ( {S}_{z} - {S}_{last} ) \vert}{{S}_{z}} \geq Δ s$$

where S_{z} is the most recent sample value of the signal 400, Sₗₐₛₜ is the value of the signal 400 the last time the value was transmitted, and Δs is the threshold difference in the values of the signal 400, expressed as a percentage.

FIG. 16C depicts an embodiment in which data transmission is triggered based on accumulation of change amount (e.g., if the accumulated change each time a value is sampled or calculated since the last sample was sent exceeds x %):

$${{\sum }_{j = last + 1}}^{z} \vert \frac{{S}_{j - 1} + {S}_{j}}{2} - {S}_{last} \vert {T}_{j} \geq Δ I$$

where S is a sample value, T is a time, and ΔI is expressed as a percentage.

FIG. 16D depicts an embodiment in which data transmission is triggered based on trends. For example, a transmission may be triggered if the value of the signal 400 changes in the same direction for n sample intervals. In FIG. 16D, the value of n is 3.

As will be understood, the various trigger types described in the paragraphs above with reference to FIGS. 16A-16D may be employed in any combination.

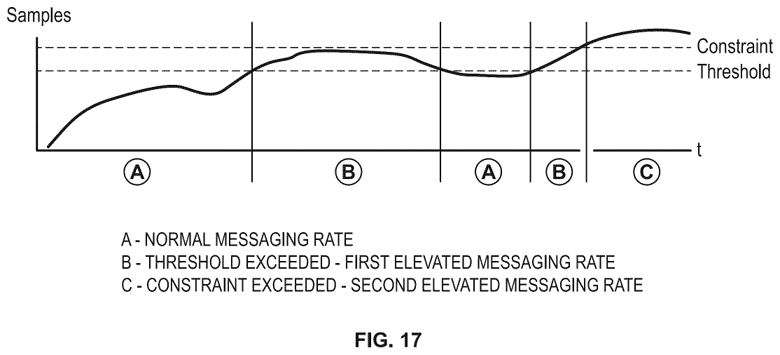

Similar to or in addition to the adjustments to event triggers described above with respect to more traditional process control systems, event triggers can be made according to the state of the system, changes in the state of the system, variables running close to constraints, or other conditions. For example, as described above, messaging related to a parameter may occur more (or less, if desired) frequently in response to a change in a set point for the parameter. As another example, communications could be more frequent when the process is operating outside of or near thresholds or constraints, as depicted in FIG. 17. As exemplified in FIG. 17, the communication of sample values may occur at a normal rate when the sampled value is in a normal operating range (e.g., below an upper threshold, above a lower threshold, etc.); in this case, the normal communication rate is employed in regions “A” in which the sampled value is below a threshold. A second, elevated rate of communications may be employed when the sampled value exceeds a threshold (e.g., rises above an upper threshold or falls below a lower threshold), as depicted in the regions “B” in FIG. 17. A second elevated rate (higher than the normal rate and the elevated rate) may be employed when the sampled value exceeds an upper or lower constraint value, as depicted in the region “C” in FIG. 17.

Of course, in most instances, the sampling rate of the value will be equal to or greater than the current communication rate. For instance, in embodiments, a sampling rate for a parameter may be constant and more frequent than the second elevated communication rate, such that, even when the value of the sampled parameter exceeds a constraint, and the value is communicated most frequently, the parameter value is sampled at least as frequently as it is communicated. In other embodiments, both the sampling rate and the communication rate may be increased depending on the operating condition (e.g., normal operation, exceeding a threshold, exceeding a constraint).

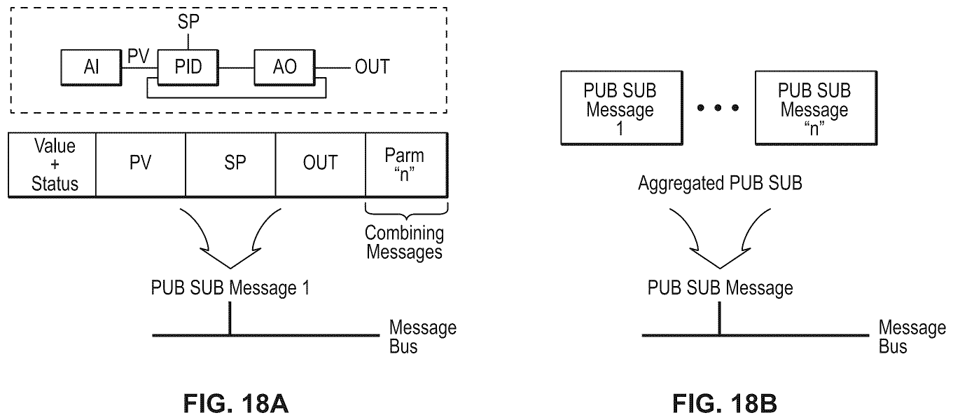

Additionally or alternatively, communications may be reduced by combining and compressing message payloads. Microservices exchange state information via communication messages that typically take the form of a publish-subscribe (“PubSub”) architecture. PubSub messaging typically includes significant processing overhead and, as a result, most provides of cloud services impose a cost for each PubSub message that traverses the cloud network. For at least this reason, it is important to reduce both the frequency with which PubSub messages are transmitted, and to fill each Ethernet frame (because cost is determined by message count, not message size). This can be accomplished by combining messaging for multiple parameters into a single PubSub message, as depicted in FIG. 18A, and/or by combining multiple PubSub messages together into one PubSub message, as depicted in FIG. 18B.

In embodiments, a dynamic PubSub messaging scheme may be implemented to assist with facilitating the goals above (e.g., reducing communications, combining payloads, etc.). In the dynamic PubSub messaging scheme, subscribers (i.e., entities in the system) may subscribe and unsubscribe from subjects (e.g., topics, parameters, alarms, etc.) of interest. Subscribers must periodically renew their interest in parameters or other content or they will be pruned from the PubSub messages including those parameters or content. When there are no longer any subscribers to a parameter or content, then the parameter or content is pruned from the communications, decreasing the number of messages and/or allowing for other payload data to take the place of the pruned data in a particular message.

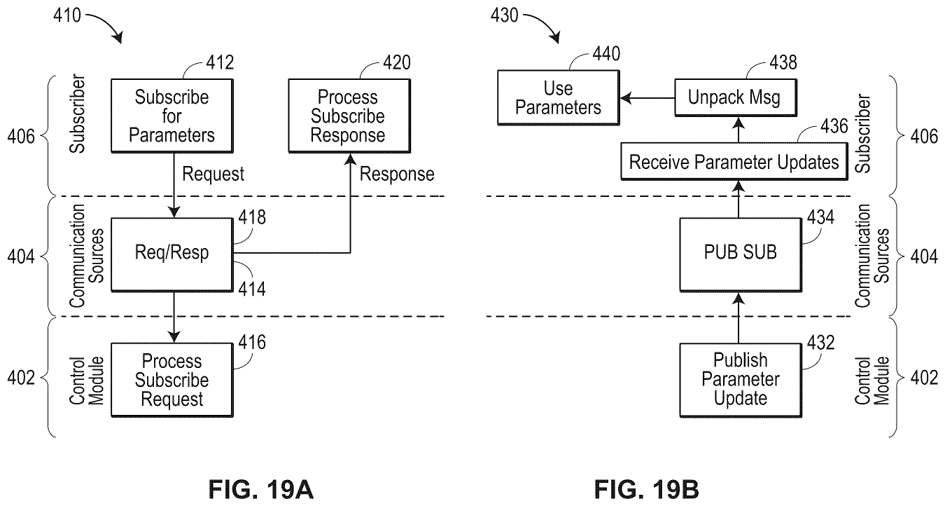

FIGS. 19A and 19B depict, respectively, methods 410, 430 for subscribing to a parameter (or other data) and methods for publishing a parameter (or other data). In each of the methods 410, 430, there are a publisher/control module level 402, a communications services level 404, and a subscriber level 406. The entities at the publisher/control module level 402 may include any entity that is producing data for consumption by another entity, including, without limitation, control modules, controllers, field devices, function blocks, applications, microservices, I/O devices, etc. The communications services level 404 includes, for example, a message broker, I/O server, aggregator, etc. that is programmed to direct messages between publishers and subscribers, track subscriptions, package published data into messages for transmission to subscribers, and transmit each message to subscribers of the data in the message payload. The subscriber level 406 includes any entity that is consuming published data and may include, without limitation, control modules, controllers, field devices, function blocks, applications, microservices, I/O devices, etc.

To subscribe, a subscriber sends to the communication services module (e.g., to a message broker) a subscription request for one or more parameters (block 412). The request is received by the communication services module, recorded in the communication services module, and forwarded to the publishing entity (block 414). The publishing entity processes the subscription request, making a record internally that the publishing entity needs to publish the requested data (potentially, in accordance with one or more parameters, such as timing, indicated in the subscription request) (block 416). The publishing entity sends a confirmatory response to the communication services module to confirm the subscription, and the communication services module sends a responsive communication to the subscriber indicating that the subscription is established (block 418). The subscriber processes the subscribe response (block 420).

With reference to FIG. 19B, once a subscription is established between a subscriber and a publishing entity, the publishing entity publishes (to the communication services module) the requested data (block 432). The publishing entity receives the published data, determines which subscriber(s) requested the published data, and packages the published data into a message to be communicated to the subscribers of the data in the message (block 434). The data in the message may include other published data, from the same or different publishers, such that the data payload of the message is full or nearly full, in embodiments, and the message may be transmitted to all subscribers that subscribe to any of the data contained in the message payload. The message is received by the subscriber(s) (block 436), unpacked by each of the subscriber-recipients of the message (block 438), and each subscriber uses the parameters to which they have respectively, subscribed (block 440). Where a message payload includes data for multiple subscribers, each subscriber uses the data to which it has subscribed, and discards the data that is not of any interest.

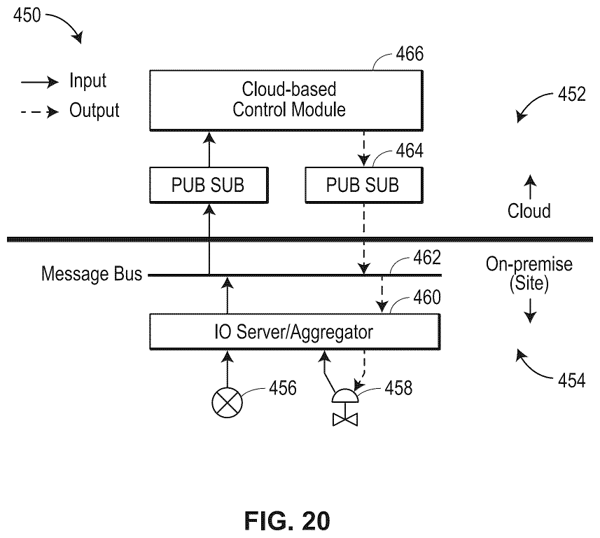

While there are any number of embodiments that could be implemented for communicating I/O values between on-premises field devices and elements (e.g., microservices) operating as part of a cloud-enabled compute fabric, FIG. 20 depicts one such embodiment. In FIG. 20, elements of a process control system 450 are divided among cloud-based components 452 and on-premises components 454. In FIG. 20, field devices 456, 458 are located on-premises at the plant, and are coupled to an I/O server and/or aggregator 460, also located on-premises. The I/O server and/or aggregator 460 is coupled to a messaging bus 462 located on-premises and communicatively coupled (e.g., via the Internet) to a cloud-enabled portion of the compute fabric, in which message brokers 464, communicating between a controller module 466 instantiated in the cloud-enabled portion of the compute fabric and the message bus 462, facilitate the publish/subscribe transactions on the cloud-enabled portion 452 of the compute fabric.

However, while various components are depicted in FIG. 20 as being part of the on-premises compute fabric 454 or as part of the cloud-enabled compute fabric 452, it should be understood that the methods described herein are adaptable to embodiments in which different, additional, more, or fewer components are part of the cloud-enabled compute portion 452 of the compute fabric. With reference, for example, to FIG. 9, embodiments of a cloud-enabled compute-fabric based process control architecture may be primarily reliant on the compute fabric and, as a result, may limit on-premises devices to transmitters, actuators, and other components that measure or physically effect a control function, while almost all other components—including, by way of example, the controller 222, the I/O 226, 227, the input and output modules 228—may be instantiated as microservices on a cloud-enabled portion of the compute fabric. Moreover, in embodiments, the field devices themselves may be digitally “twinned” in the compute fabric, such that the memory 244 (and even the transmitter 238 and the processor 242) of the transmitter 236 is similarly instantiated as a microservice in the compute fabric. (In such an instance, the sensor 240 would communicate raw data in digital form directly onto the message bus, and the raw data would be processed by the instantiated microservice digital twin of the field device.)

In any event, the event-based control and communication strategies described above with respect to traditional process control architectures may also be implemented in software-defined control architectures that operate on a compute fabric in which many or most components and services are instantiated microservices, rather than dedicated hardware. Specifically, the strategies described above may be implemented in a compute fabric that includes a physical layer comprising one or more computer processing and/or storage devices and an application layer that includes computer implemented software modules that may be implemented on the physical layer to perform various control, monitoring, and configuration activities using the pool of physical devices.

The techniques for optimizing communication and for doing so in the context of event-based control, require some additional consideration in certain control configurations. Specifically, in control configurations implementing PIDPlus algorithms in a cloud-based control environment, the PIDPlus algorithms must be modified.

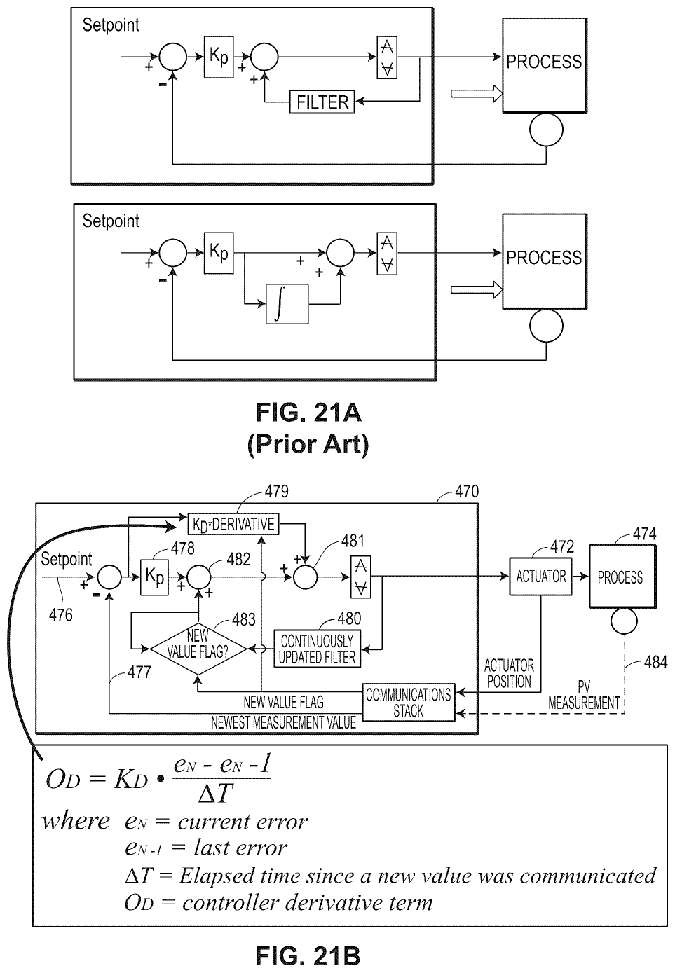

FIG. 21A illustrates known implementations of PI control. In many commercial distributed control systems, the reset contribution of the PID module is realized using a positive feedback network (top of FIG. 21A) in which the time constant of the filter in this network defines the reset time in seconds per repeat. This approach is commonly used because it supports the implementation of external reset for use in cascade and override applications.

When the measurement is not updated on a periodic basis, however, such as would be the case in the event and/or trigger-based reporting configurations described herein, the calculated reset action and rate may not be appropriate. If control is only executed when a new measurement is communicated, this can result in a delayed control response to setpoint changes and feed-forward action on measured disturbances that occur between updates. Also, as the PID execution period is increased, the basic assumptions made in the PID design of the reset and derivative calculation may no longer be valid. As a result, to provide better control using a wireless measurement, the PID must be restructured to correctly handle continuous measurement updates communicated on a non-periodic basis and/or much slower than 4 times the process response time (the typical rate).

One could be excused for first thinking that there is no technical solution that minimizes how often a measurement is communicated without compromising control performance, because the solution is not immediately obvious. However, when the PID reset is implemented using a positive-feedback network, the filter-time constant is a direct reflection of the process dynamic response. Based on this, the reset calculation of the PID is modified for wireless control is illustrated in FIG. 21B. In the illustrated implementation, the positive feedback network used to create the reset contribution is modified such that it (1) maintains the last calculated filter output until a new measurement is communicated, and (2) uses the new filter output as the positive feedback contribution when a new measurement is received. For processes that require derivative action, the contribution of the reset to the PID output is recomputed and updated only when a new measurement is received. The derivative calculation uses the elapsed time since the last new measurement. The reset calculation automatically compensates for setpoint change and measurement update rate. The derivate component accounts for a new measurement value not being available each execution of the PID. As a result, there is no need to modify tuning for cloud-based control.

With reference still to FIG. 21B, the figure depicts an example PID function block 470 coupled to an actuator 472 that, in turn, is coupled to a process 474. A setpoint 476 is compared to the newest measurement value 477 received, and the difference (an error) is passed to the proportional and derivative blocks (478 and 479, respectively). The derivative block 479 determines a controller derivative term based on the difference between the current error, the last error, and the time elapsed since a new value was communicated. A filter 480 is continuously updated according to the value from a summation 481 of the derivative output and the summation 482 of the proportional output and the output of the filter 480. However, the output of the filter 480 is only provided to the summation 482 when a new value flag 483 is true. The new value flag 482 is set to true when a new process variable measurement 484 is transmitted to the function block 470 from the process 474.

What is claimed:

1. A method for event-based control in a process plant, the method comprising:
storing in a first field device a default update period value for a process variable in the process plant;
storing in the first field device a deadband value for the process variable;
storing in the first field device a setpoint tolerance value for the process variable;
receiving a setpoint value corresponding to the process variable, the setpoint received from a process controller implementing a control strategy in the process plant or from a second field device that receives the setpoint from the process controller;
periodically determining a current measured value of the process variable;
transmitting to the process controller the current measured value of the process variable if any one of the following conditions is met:
(1) an amount of time elapsed since a most recent transmitted value was transmitted exceeds the default update period value;
(2) a difference between the current measured value of the process variable and a most recent measured value of the process variable exceeds the deadband value;
(3) a difference between the current measured value of the process variable and the setpoint value exceeds the setpoint tolerance value.

2. A method according to claim 1, wherein storing in the first field device the setpoint tolerance value for the process variable comprises receiving from the process controller the setpoint tolerance value.

3. A method according to claim 1, wherein each of the default update period value, the deadband value, the setpoint tolerance value, and the setpoint value is associated with a first control loop, wherein the method further comprises:
storing in the first field device a second default update period value for the process variable in the process plant, the second default update period value associated with a second control loop;
storing in the first field device a second deadband value for the process variable, the second deadband value associated with the second control loop;
storing in the first field device a second setpoint tolerance value for the process variable, the second setpoint tolerance value associated with the second control loop; and
transmitting to the process controller the current measured value of the process variable if any one of the following conditions is met:
(1) an amount of time elapsed since a most recent transmitted value was transmitted exceeds the second default update period value;
(2) a difference between the current measured value of the process variable and a most recent measured value of the process variable exceeds the second deadband value;
(3) a difference between the current measured value of the process variable and the setpoint value exceeds the second setpoint tolerance value.

4. A method according to claim 1, wherein the deadband value is programmed to change in real-time according to the difference between the setpoint value and the process variable.

5. A method according to claim 4, wherein the deadband value is programmed to decrease, thereby narrowing the deadband, as the difference between the setpoint value and the process variable decreases.

6. A method according to claim 5, wherein the deadband value is programmed to increase, thereby widening the deadband, when the difference between the setpoint value and the process variable reaches zero.

7. A method according to claim 1, further comprising:
receiving at the first field device, from the process controller, a time constant associated with the process variable; and
(1) adjusting the deadband value according to the time constant;
(2) adjusting the default update period value according to the time constant; or
(3) adjusting both the deadband value and the default update period value according to the time constant.

8. A process control field device comprising:
a sensor that is configured to be coupled to a process in an industrial process plant, configured to obtain a measurement of a process variable of the process plant;
a transmitter that is configured to be communicatively coupled to a process controller implementing a control strategy in the process plant and to transmit to the process controller the measurement of the process variable;
a memory device that is configured to store (i) a deadband value for the process variable, (ii) a setpoint tolerance value for the process variable, and (iii) a default update period value for the process variable;
an input that is configured to be communicatively coupled to the process controller or to a second field device, the input configured to receive from the process controller or the second field device (i) a current setpoint value corresponding to the measured process variable,
a computer processor programmed to:
periodically determine a current measured value of the process variable; and
transmit to the process controller the current measured value of the process variable if any one of the following conditions is met:
(1) an amount of time elapsed since a most recent transmitted value was transmitted exceeds the default update period value;
(2) a difference between the current measured value of the process variable and a most recent measured value of the process variable exceeds the deadband value;
(3) a difference between the current measured value of the process variable and the setpoint value exceeds the setpoint tolerance value.

9. A process control field device according to claim 8, wherein the computer processor is further programmed to receive from the process controller the setpoint tolerance value.

10. A process control field device according to claim 8, wherein each of the default update period value, the deadband value, the setpoint tolerance value, and the setpoint value is associated with a first control loop,
wherein the memory further stores:
a second default update period value for the process variable in the process plant, the second default update period value associated with a second control loop;
a second deadband value for the process variable, the second deadband value associated with the second control loop; and
a second setpoint tolerance value for the process variable, the second setpoint tolerance value associated with the second control loop, and
wherein the computer processor is further configured to transmit to the process controller the current measured value of the process variable if any one of the following conditions is met:
(1) an amount of time elapsed since a most recent transmitted value was transmitted exceeds the second default update period value;
(2) a difference between the current measured value of the process variable and a most recent measured value of the process variable exceeds the second deadband value;
(3) a difference between the current measured value of the process variable and the setpoint value exceeds the second setpoint tolerance value.

11. A process control field device according to claim 8, wherein the computer processor is further programmed to change in real-time according to a difference between the setpoint value and the process variable.

12. A process control field device according to claim 11, wherein the computer processor is further programmed to decrease the deadband value, thereby narrowing the deadband, as the difference between the setpoint value and the process variable decreases.

13. A process control field device according to claim 12, wherein the computer processor is further programmed to increase the deadband value, thereby widening the deadband, when the difference between the setpoint value and the process variable reach zero.

14. A process control field device according to claim 8, wherein the computer processor is further programmed to:
receive, from the process controller, a time constant associated with the process variable; and
(1) adjust the deadband value according to the time constant;
(2) adjust the default update period value according to the time constant; or
(3) adjust both the deadband value and the default update period value according to the time constant.

15. A process controller, comprising:
a computer processor that is configured to:
receive, from a transmitter of a first field device in a process plant measuring a process variable of the process plant, measurements of the process variable, the transmitter transmitting the measurements at a first rate; and
transmit, to the transmitter associated with the first field device, a setpoint value corresponding to the process variable.

16. A process controller according to claim 15, wherein the computer processor is further configured to:
determine that the first field device received the setpoint value, based upon receiving, at a second rate different from the first rate, further measurements from the transmitter of the first field device.

17. A process controller according to claim 16, wherein the second rate is dependent on a difference between the setpoint value and a current value of the process variable.

18. A process controller according to claim 15, wherein the computer processor is further configured to transmit, to the transmitter of the first field device, a setpoint tolerance value.
